(19) United States
(12) Patent Application Publication
(10) Pub. No.: US 2019/0175429 A1
(43) Pub. Date: Jun. 13, 2019

(54) SUPPORT FRAME WITH OPTIONAL ANTI-SKID/ANTI-TIP STRUCTURE

(71) Applicant: Lucent Medical Systems, Inc., Kirkland, WA (US)

(72) Inventors: Fred E. Silverstein, Seattle, WA (US); Curtis S. King, Kirkland, WA (US); Robert N. Golden, Kirkland, WA (US); Steve Vincent, Kirkland, WA (US)

(21) Appl. No.: 16/274,105

(22) Filed: Feb. 12, 2019

Related U.S. Application Data
(63) Continuation-in-part of application No. 15/074,952, filed on Mar. 18, 2016.
(60) Provisional application No. 62/135,557, filed on Mar. 19, 2015.

(51) Int. Cl. A61G 7/10; A61G 7/053

(52) U.S. Cl. CPC A61G 7/1038; A61G 7/1019; A61G 7/1011; A61G 7/053

(57) ABSTRACT

A support structure device with an optional anti-skid/anti-tip structure is configured to assist a human patient to rise. The support structure with the optional anti-skid/anti-tip structure includes a tube bent into a shape described by way of a reference frustum such as a four-sided truncated pyramid. Each side of a top rectangular perimeter of the frustum is shorter than a corresponding side of the bottom rectangular perimeter, and each parallel side of a first trapezoidal perimeter of the frustum is shorter than a corresponding parallel side of a second trapezoidal perimeter. The anti-skid/anti-tip structure optionally includes a plurality of first coupling locations, an enclosure region, and anti-skid/anti-tip wings having anti-skid/anti-tip components. The anti-skid/anti-tip wings reduce the likelihood of or even prevent rolling, slipping, tipping, sliding, and other undesirable motion of the support structure thereby allowing a human patient to rise off a ground or a floor safely with or without the supervision of another individual.

### CROSS-REFERENCE TO RELATED APPLICATIONS

This continuation-in-part application claims the priority benefit of U.S. patent application Ser. No. 15/074,952, filed Mar. 18, 2016, which claims priority to U.S. Provisional Patent Application No. 62/135,557, filed Mar. 19, 2015. Each of these applications is hereby incorporated by reference in its entirety.

### BACKGROUND

### Technical Field

The present disclosure generally relates to a support frame used to help a person rise up from a floor or the ground. More particularly, but not exclusively, the present disclosure relates to a vertically stable support structure sufficient for an infirmed person to lean on as the person rises from the floor or the ground.

### Description of the Related Art

After many medical procedures, such as hip or knee replacement, a patient finds it difficult to rise from the floor or from ground level. In some cases, pain prevents the patient from moving their knee below their body such that they can begin the process to rise. In other cases, the artificial joint does not provide a full range of motion, and once again, the patient is not physically or comfortably able to move their knee below their body. In many cases, the condition persists long after the post-operative recovery of the patient and the person has resumed a normal life.

The subject matter discussed in the Background section is not necessarily prior art and should not be assumed to be prior art merely as a result of its discussion in the Background section. Along these lines, any recognition of problems in the prior art discussed in Background section or associated with such subject matter should not be treated as prior art unless expressly stated to be prior art. Instead, the discussion of any subject matter in the Background section should be treated as part of the inventor's approach to the particular problem, which in and of itself may include inventive subject matter.

### BRIEF SUMMARY

In accordance with some embodiments described herein, a vertically stable support structure is provided. A mobility-restricted person can use the device to rise up from the floor or the ground by placing their hands on the support structure and lifting their head and torso sufficiently up that the person can move their leg below their body and thus begin the process of rising. The person may rise to a full standing position, or the person may rise enough to lean or sit on another structure.

In a first embodiment, a method is performed by a human being to stand. The human being has a body, two hands, two legs, two feet, and at least one debilitated joint. A first act includes positioning a support structure in front of the human being. The support structure is described by way of a reference frustum, which has a first planar side and a third planar side each having a first trapezoidal perimeter, a second planar side and a fourth planar side each having second trapezoidal perimeter, a planar top having a first rectangular perimeter, and a planar bottom having a second rectangular perimeter. Each side of the first rectangular perimeter is shorter than a corresponding side of the second rectangular perimeter, and each parallel side of the first trapezoidal perimeter is shorter than a corresponding parallel side of the second trapezoidal perimeter. The reference frustum has a height between 10 and 20 inches, the first rectangular perimeter has a length between 10 and 16 inches, the first rectangular perimeter has a width between 6 and 14 inches, the second rectangular perimeter has a length between 12 and 18 inches, and the second rectangular perimeter has a width between 8 and 16 inches. The support structure has horizontal support portions including a first horizontal support member corresponding to a first edge of the reference frustum formed by the first planar side and the planar top, and the support structure has a second horizontal support member corresponding to a second edge of the reference frustum formed by the third planar side and the planar top. The support structure has vertical support portions including a first vertical portion corresponding to a third edge of the reference frustum formed by the first planar side and the second planar side, a second vertical portion corresponding to a fourth edge of the reference frustum formed by the second planar side and the third planar side, a third vertical part corresponding to a fifth edge of the reference frustum formed by the third planar side and the fourth planar side, and a fourth vertical part corresponding to a sixth edge of the reference frustum formed by the fourth planar side and the first planar side. In the method, the human being grasps the first horizontal support member with a first of the two hands, grasps the second horizontal support member with a second of the two hands, swings a first of the two legs at least partially under the body, supports at least a first portion of the body through the two hands grasping the support structure, supports at least a second portion of the body with the first of the two legs, and raises the body upwards to a standing position.

In a second embodiment, a support structure device to assist a human patient to rise includes one or more substantially tubular components formed into a shape described by way of a reference frustum. The reference frustum has a first planar side and a third planar side each having a first trapezoidal perimeter, a second planar side and a fourth planar side each having second trapezoidal perimeter, a planar top having a first rectangular perimeter, and a planar bottom having a second rectangular perimeter. Each side of the first rectangular perimeter is shorter than a corresponding side of the second rectangular perimeter, and each parallel side of the first trapezoidal perimeter is shorter than a corresponding parallel side of the second trapezoidal perimeter. The reference frustum has a height between 10 and 20 inches, the first rectangular perimeter has a length between 10 and 16 inches, the first rectangular perimeter has a width between 6 and 14 inches, the second rectangular perimeter has a length between 12 and 18 inches, and the second rectangular perimeter has a width between 8 and 16 inches.

In another embodiment, a support frame assists a human being to move upwards. The human being has two arms, two hands, two legs, and at least one infirmed joint. The support frame has a single conduit structure suitably bent into a shape described by way of a reference frustum. The reference frustum has a first planar side and a third planar side each having a first trapezoidal perimeter, a second planar side and a fourth planar side each having second trapezoidal perimeter, a planar top having a first rectangular perimeter, and a planar bottom having a second rectangular perimeter. Each side of the first rectangular perimeter is shorter than a corresponding side of the second rectangular perimeter, and each parallel side of the first trapezoidal perimeter is shorter than a corresponding parallel side of the second trapezoidal perimeter. The reference frustum has a height between 10 and 20 inches, the first rectangular perimeter has a length between 10 and 16 inches, the first rectangular perimeter has a width between 6 and 14 inches, the second rectangular perimeter has a length between 12 and 18 inches, and the second rectangular perimeter has a width between 8 and 16 inches.

In some embodiments, a support structure device is combined with an optional anti-skid/anti-tip structure to prevent or reduce the likelihood of rolling, tipping, slipping, sliding, or other undesirable motion of the support structure as a patient uses the support structure to rise off a floor or off the ground. The anti-skid/anti-tip structure optionally includes anti-skid/anti-tip wings, coupling locations, and anti-skid/anti-tip components. In addition, the anti-skid/anti-tip structure may optionally have at least one identifiable feature.

For example, in a fourth embodiment, a method is performed by a human being to stand, the human being having a body, two hands, two legs, two feet, and at least one debilitated joint. The method includes positioning a support structure in front of the human being, wherein the support structure described by way of a reference frustum.

In the fourth embodiment, the reference frustum has a first planar side and a third planar side each having a first trapezoidal perimeter, a second planar side and a fourth planar side each having second trapezoidal perimeter, a planar top having a first rectangular perimeter, and a planar bottom having a second rectangular perimeter. Here, each side of the first rectangular perimeter is shorter than a corresponding side of the second rectangular perimeter, and here, each parallel side of the first trapezoidal perimeter is shorter than a corresponding parallel side of the second trapezoidal perimeter. Also here, the reference frustum has a height between 10 and 20 inches, the first rectangular perimeter has a length between 10 and 16 inches, the first rectangular perimeter has a width between 6 and 14 inches, the second rectangular perimeter has a length between 12 and 18 inches, and the second rectangular perimeter has a width between 8 and 16 inches.

In the fourth embodiment, the support structure has horizontal support portions. The horizontal support portions include a first horizontal support member corresponding to a first edge of the reference frustum formed by the first planar side and the planar top, a second horizontal support member corresponding to a second edge of the reference frustum formed by the third planar side and the planar top, and a lower horizontal support member corresponding to a third edge of the reference frustum formed by the fourth planar side and the planar bottom. The lower horizontal support member is substantially transverse to the first and the second horizontal support members,

In the fourth embodiment, the support structure has vertical support portions. The vertical support portions include a first vertical portion corresponding to a third edge of the reference frustum formed by the first planar side and the second planar side, a second vertical portion corresponding to a fourth edge of the reference frustum formed by the second planar side and the third planar side, a third vertical part corresponding to a fifth edge of the reference frustum formed by the third planar side and the fourth planar side, and a fourth vertical part corresponding to a sixth edge of the reference frustum formed by the fourth planar side and the first planar side.

The support structure of fourth embodiment also includes an anti-skid/anti-tip structure that surrounds the lower horizontal support member of the support structure. The anti-skid/anti-tip structure has a plurality of coupling locations, a plurality of coupling components coupling the anti-skid/anti-tip structure about the support structure at each coupling location of the plurality of coupling locations, and a plurality of anti-skid/anti-tip components formed at a base of the anti-skid/anti-tip structure.

The method of the fourth embodiment includes acts of grasping the first horizontal support member with a first of the two hands, grasping the second horizontal support member with a second of the two hands, swinging a first of the two legs at least partially under the body, supporting at least a first portion of the body through the two hands grasping the support structure, supporting at least a second portion of the body with the first of the two legs, and raising the body upwards to a standing position.

In some cases of the fourth embodiment, the debilitated joint is an artificial hip joint or an artificial knee joint. In some of these or other cases, the human being is on a floor or the ground. In some cases, the method includes placing the support structure in proximity to the human being prior to the human being lying on the floor or the ground. And in some cases, the method also includes releasing one of the two hands from the respective first or second horizontal support member while raising the body upwards.

In a fifth embodiment, a support structure device to assist a human patient to rise includes one or more substantially tubular components formed into a shape described by way of a reference frustum. The reference frustum has a first planar side and a third planar side each having a first trapezoidal perimeter, a second planar side and a fourth planar side each having second trapezoidal perimeter, a planar top having a first rectangular perimeter, and a planar bottom having a second rectangular perimeter. Each side of the first rectangular perimeter is shorter than a corresponding side of the second rectangular perimeter, and each parallel side of the first trapezoidal perimeter is shorter than a corresponding parallel side of the second trapezoidal perimeter. Also, the reference frustum has a height between 10 and 20 inches, the first rectangular perimeter has a length between 10 and 16 inches, the first rectangular perimeter has a width between 6 and 14 inches, the second rectangular perimeter has a length between 12 and 18 inches, and the second rectangular perimeter has a width between 8 and 16 inches.

In the fifth embodiment, the support structure has horizontal support portions. The horizontal support portions include a first horizontal support member corresponding to a first edge of the reference frustum formed by the first planar side and the planar top, a second horizontal support member corresponding to a second edge of the reference frustum formed by the third planar side and the planar top, and a lower horizontal support member corresponding to a third edge of the reference frustum formed by the fourth planar side and the planar bottom, the lower horizontal support member being substantially transverse to the first and the second horizontal support members. The support structure also has an anti-skid/anti-tip structure having a first half and a second half. The first half and the second half of the anti-skid/anti-tip structure are arranged to surround the lower horizontal support member. The anti-skid/anti-tip structure has an enclosure region that encloses the lower horizontal support member and anti-skid/anti-tip wings coupled to the enclosure region and located at the ends of the enclosure region. The anti-skid/anti-tip structure has a plurality of coupling locations on the anti-skid/anti-tip wings and a plurality of coupling components coupling the first half and the second half of the anti-skid/anti-tip structure at each coupling location of the plurality of coupling locations.

In some cases, the support structure device of the fifth embodiment includes a plurality of anti-skid/anti-tip components formed at respective bases of the anti-skid/anti-tip wings. In some of these cases, the plurality of anti-skid/anti-tip components are formed as a plurality of ellipses, wherein the plurality of anti-skid/anti-tip components extend through the base of the anti-skid/anti-tip structure, and wherein the plurality of anti-skid/anti-tip components are substantially evenly spaced along the base of the anti-skid/anti-tip structure.

In some cases of the support structure device of the fifth embodiment, at least some of the one or more substantially tubular components are stainless steel, aluminum, an aluminum alloy, or a composite material. And in some cases, the support structure device includes an anti-skid material applied to each terminal end of the anti-skid/anti-tip structure wherein a first terminal end of the anti-skid/anti-tip structure corresponds to a left-most point of the reference frustum formed by the first trapezoidal perimeter and the third trapezoidal perimeter and a second terminal end of the anti-skid/anti-tip structure corresponds to right-most point of the reference frustum formed by the second trapezoidal perimeter and the third trapezoidal perimeter. In some of these cases, the anti-skid material and the anti-skid/anti-tip structure are substantially a polyurethane material or a rubber material.

In some cases, the support structure device of the fifth embodiment includes a first fastener structure positioned at a first location of the lower horizontal support member, and a second fastener structure positioned at a first location of the anti-skid/anti-tip structure, wherein the second fastener structure of the anti-skid/anti-tip structure is arranged to align with the first fastener structure of the lower horizontal support member.

In some cases of the fifth embodiment, where at least some of the one or more substantially tubular components of the support structure device are stainless steel, aluminum, an aluminum alloy, or a composite material, the first half of the anti-skid/anti-tip structure and the second half of the anti-skid/anti-tip structure are substantially mirror images of each other. And in some cases, at least some portion of the one or more substantially tubular components includes a chromed surface, an electrochemically colored surface, or an enamel surface.

In some cases of the fifth embodiment, at least one portion of the one or more substantially tubular components of the support structure device or at least one portion of the anti-skid/anti-tip structure includes at least one identifiable feature. In some of these cases, the at least one identifiable feature includes at least one of a decoration, a visible marking, a textured surface, and an anatomically complimentary structure.

In a sixth embodiment, a support frame is arranged for assisting a human being to move upwards. The human being has two arms, two hands, two legs, and at least one infirmed joint. The support frame includes a single conduit structure suitably bent into a shape described by way of a reference frustum. The reference frustum has a first planar side and a third planar side each having a first trapezoidal perimeter, a second planar side and a fourth planar side each having second trapezoidal perimeter, a planar top having a first rectangular perimeter, and a planar bottom having a second rectangular perimeter. Each side of the first rectangular perimeter is shorter than a corresponding side of the second rectangular perimeter, and each parallel side of the first trapezoidal perimeter is shorter than a corresponding parallel side of the second trapezoidal perimeter. The reference frustum has a height between 10 and 20 inches, the first rectangular perimeter has a length between 10 and 16 inches, the first rectangular perimeter has a width between 6 and 14 inches, the second rectangular perimeter has a length between 12 and 18 inches, and the second rectangular perimeter has a width between 8 and 16 inches,

In the sixth embodiment, the single conduit structure has horizontal support portions including a first horizontal support member corresponding to a first edge of the reference frustum formed by the first planar side and the planar top, a second horizontal support member corresponding to a second edge of the reference frustum formed by the third planar side and the planar top, and a lower horizontal support member corresponding to a third edge of the reference frustum formed by the fourth planar side and the planar bottom, the lower horizontal support member being substantially transverse to the first and the second horizontal support members, the lower horizontal support member having a first end and a second end. The support frame of the sixth embodiment also has an anti-skid/anti-tip structure, which has a first anti-skid/anti-tip structure portion positioned at the first end of the lower horizontal support member, and a second anti-skid/anti-tip structure portion positioned at the second end of the lower horizontal support member.

In some cases, the single conduit structure of the support frame of the sixth embodiment has a substantially square cross-section. In these or in other cases, the support frame of the sixth embodiment has a first plurality of anti-skid/anti-tip components formed at a first base of the first anti-skid/anti-tip structure portion and a second plurality of anti-skid/anti-tip components formed at a second base of the second anti-skid/anti-tip structure portion. Here, the first and the second plurality of the anti-skid/anti-tip components extend respectively out of the first and the second base of the first and the second anti-skid/anti-tip structure portions, and the first and the second plurality of anti-skid/anti-tip components are substantially evenly spaced respectively along the first and the second base of the first and the second anti-skid/anti-tip structure portions.

These features with other objects and advantages which will become subsequently apparent reside in the details of construction and operation as more fully described hereafter and claimed, reference being had to the accompanying drawings forming a part hereof. This Brief Summary has been provided to introduce certain concepts in a simplified form that are further described in detail below in the Detailed Description. Except where otherwise expressly stated, the summary is not intended to identify key or essential features of the claimed subject matter, nor is it intended to limit the scope of the claimed subject matter.

### BRIEF DESCRIPTION OF THE SEVERAL VIEWS OF THE DRAWINGS

Non-limiting and non-exhaustive embodiments are described with reference to the following drawings, wherein like labels refer to like parts throughout the various views unless otherwise specified. The sizes and relative positions of elements in the drawings are not necessarily drawn to scale. For example, the shapes of various elements are selected, enlarged, and positioned to improve drawing legibility. The particular shapes of the elements as drawn have been selected for ease of recognition in the drawings. One or more embodiments are described hereinafter with reference to the accompanying drawings in which:

FIG. 1 is a perspective view of a support structure embodiment;

FIG. 2A is a reference frustum;

FIG. 2B is the reference frustum of FIG. 2A with reference labels identifying each edge of the frustum;

FIG. 2C is the reference frustum of FIG. 2A with the first and third sides emphasized;

FIG. 2D is the reference frustum of FIG. 2A with the second and fourth sides emphasized;

FIG. 3 illustrates a centerline of the support structure embodiment of FIG. 1;

FIG. 4 is the support structure embodiment of FIG. 1 about the centerline of FIG. 3;

FIG. 5 is a front side view of the support structure embodiment of FIG. 1;

FIG. 6 is a right side view of the support structure embodiment of FIG. 1;

FIG. 7 is a top side view of the support structure embodiment of FIG. 1;

FIG. 8 is a perspective view of the support structure embodiment of FIG. 1 about the reference frustum of FIG. 2A;

FIG. 9 is a top side view of the support structure embodiment of FIG. 1 about the reference frustum of FIG. 2A;

FIG. 10 is an exploded illustration of the support structure embodiment of FIG. 1 showing anti-skid material plugs;

FIG. 11 is another embodiment of a support structure, which is similar to the support structure embodiment of FIG. 1 with optional features;

FIG. 12 is a right side view of the support structure embodiment of FIG. 1 with anti-skid material plugs;

FIG. 13 is a perspective view of another support structure embodiment;

FIG. 14 is an exploded perspective view of another embodiment of a support structure, which is along the lines of embodiments represented in FIGS. 1-13, and which includes an optional anti-skid/anti-tip structure;

FIG. 15 is a front side view of the support structure embodiment of FIG. 14;

FIG. 16 is a front side view and a right side view of the support structure of FIG. 14;

FIG. 17 is a perspective view of the support structure embodiment of FIG. 14;

FIG. 18 is a front side view and a right side view of another embodiment of a support structure, which is along the lines of embodiments represented in FIGS. 1-13, and which includes optional anti-skid/anti-tip structures;

FIG. 19 is an isometric view of the support structure embodiment of FIG. 18;

FIG. 20 is a perspective view of another embodiment of a support structure with an optional anti-skid/anti-tip feature;

FIG. 21 is a front side view of an optional anti-skid/anti-tip component;

FIG. 22 is a back side view of the optional anti-skid/anti-tip component in FIG. 21;

FIG. 23 is a right side view of the optional anti-skid/anti-tip component in FIG. 21;

FIG. 24 is a cross-sectional view taken along 24-24 in FIG. 23 of the optional anti-skid/anti-tip component in FIG. 21;

FIG. 25 is a top side view of the optional anti-skid/anti-tip component in FIG. 21;

FIG. 26 is a zoomed in top side view of detail 26 in FIG. 25 of the optional anti-skid/anti-tip component in FIG. 21;

FIG. 27 is a front side view with a cut out at detail 28 of the optional anti-skid/anti-tip component in FIG. 21;

FIG. 28 is a zoomed in front side view of detail 28 in FIG. 27 of the optional anti-skid/anti-tip component in FIG. 21;

FIG. 29 is a front side view of another embodiment of a support structure, which is similar to the support structure embodiment of FIG. 1;

FIG. 30 is a bottom side view of the embodiment of the support structure in FIG. 29;

FIG. 31 is an exploded perspective view of another embodiment of a support structure with optional features, which is similar to the support structure embodiment of FIG. 1 with optional features;

FIG. 32 is an exploded front side view of the embodiment of the support structure with optional features in FIG. 31;

FIG. 33 is a front side view of the embodiment of the support structure with optional features as in FIGS. 31 and 32; and

FIG. 34 is a right side view of the embodiment of the support structure with optional features as in FIG. 33.

### DETAILED DESCRIPTION

Hips and knees of human beings can fail or be injured. Sometimes, the person will endure the pain, discomfort, and reduced mobility associated with the damaged joint. Other times, the person will undergo a surgical operation to replace the failing or injured joint with an artificial joint. Even when surgery is successful, some pain, discomfort, and reduced mobility may remain.

Frequently, people with affected hips and knees have difficulty raising their body off of the ground or a floor. In some cases, pain or discomfort prevents the person from positioning one of their legs below their body. In other cases, reduced mobility of one or both legs prevents such positioning. In these cases, if the person does not have a piece of furniture, a wall, or some other support mechanism nearby, it is very difficult or even impossible for the person to get up.

Recognizing the problems faced by people with one or more debilitated joints, the inventors created a support structure with many benefits.

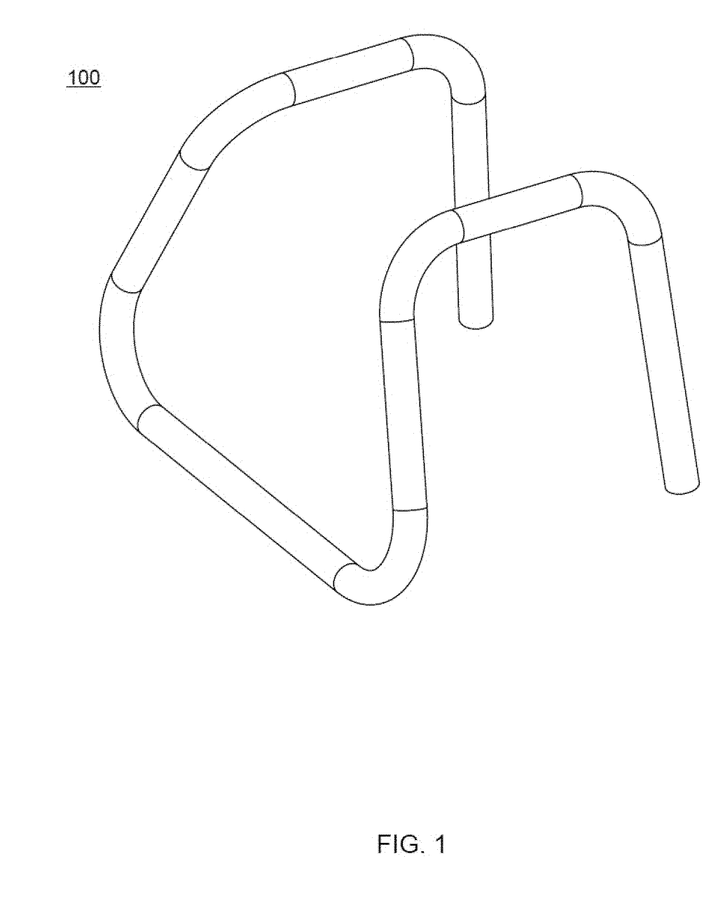

FIG. 1 is a perspective view of a support structure 100 embodiment. The support structure 100 is used by a person having at least one debilitated joint to raise their body off of the floor or the ground. Using the support structure 100, the person is often able to stand up very quickly and efficiently.

An example of use of the support structure 100 is now described. In this case, the person is aware of their debilitated joint (e.g., artificial knee, artificial hip, or the like). The person is also aware they will be lowering their body to ground level so as to exercise, for example, or to retrieve an item that has fallen on the floor, to work in a garden, or for some other reason. In this case, the person will put the support structure 100 nearby and accessible to the place on the ground or floor where the person will be, and the person will then lower their body to the ground or floor. When the person wishes to raise their body upwards to a standing position or, for example, to sit on a chair, the person will position the support structure 100 in front of themselves. The person will grasp one of the horizontal members of the support structure 100 with their left hand and the other horizontal member with their right hand. Using the support structure 100 for support and stability, the person may begin raising their upper body, and the person will swing one of their legs at least partially under their body. At this time, some portion of the person's body will be supported through their hands, which are grasping the horizontal members of the support structure 100. The person may optionally draw their other leg at least partially under their body. Once the person has at least one leg positioned under their body, the person will support at least a portion of their body with their leg, and upon doing so, the person will raise their body upwards off of the ground or floor.

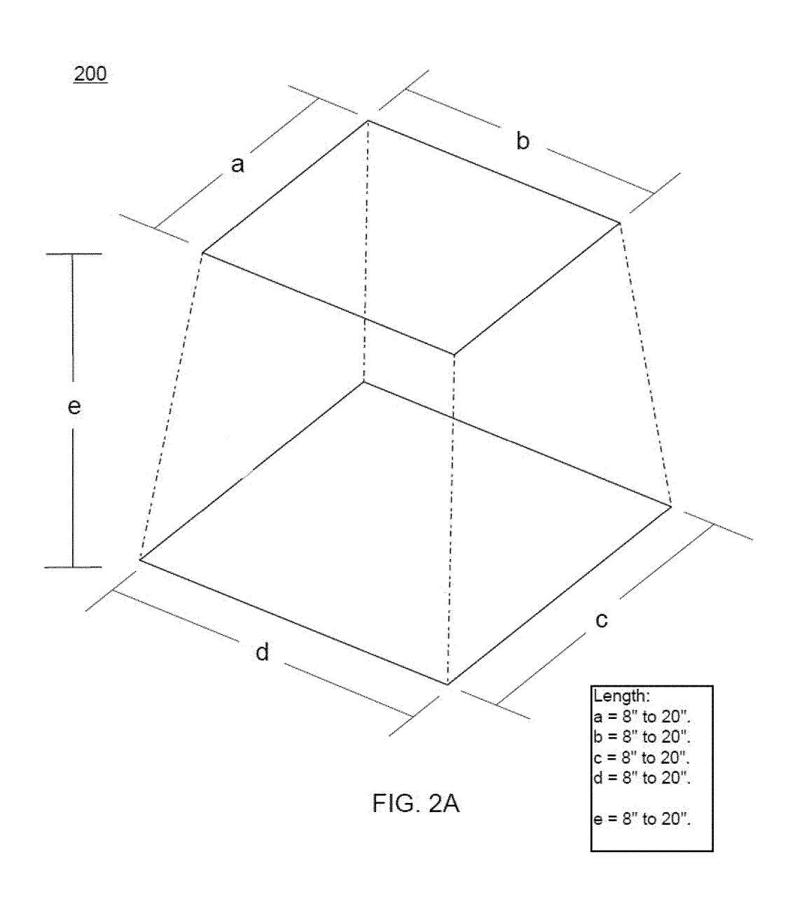

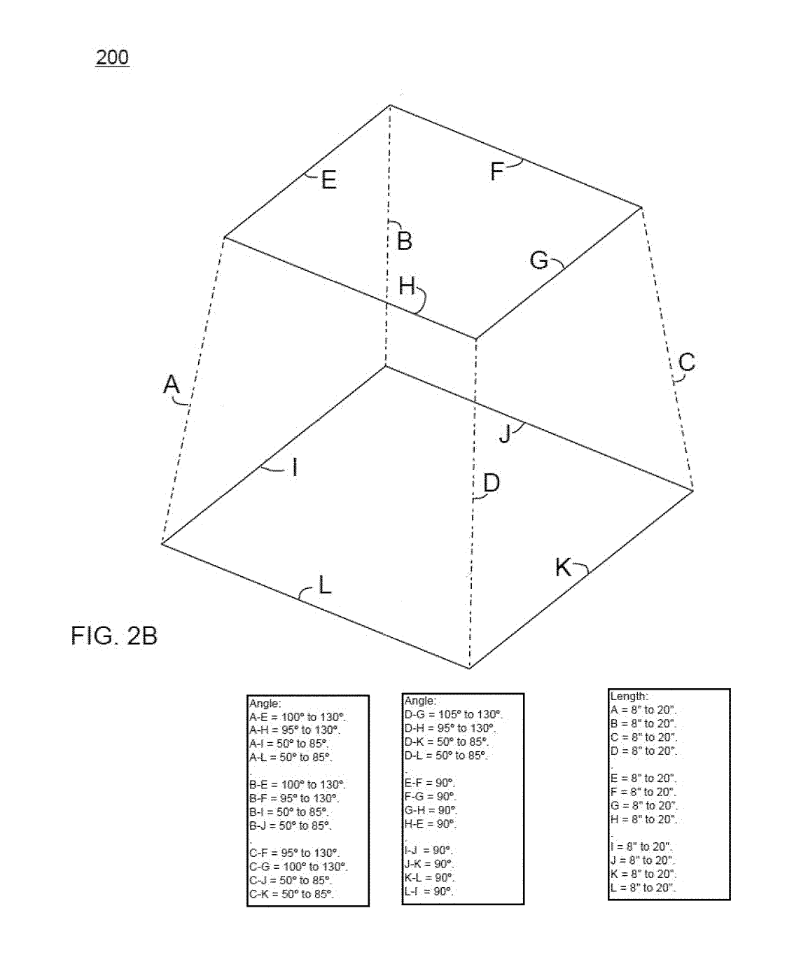

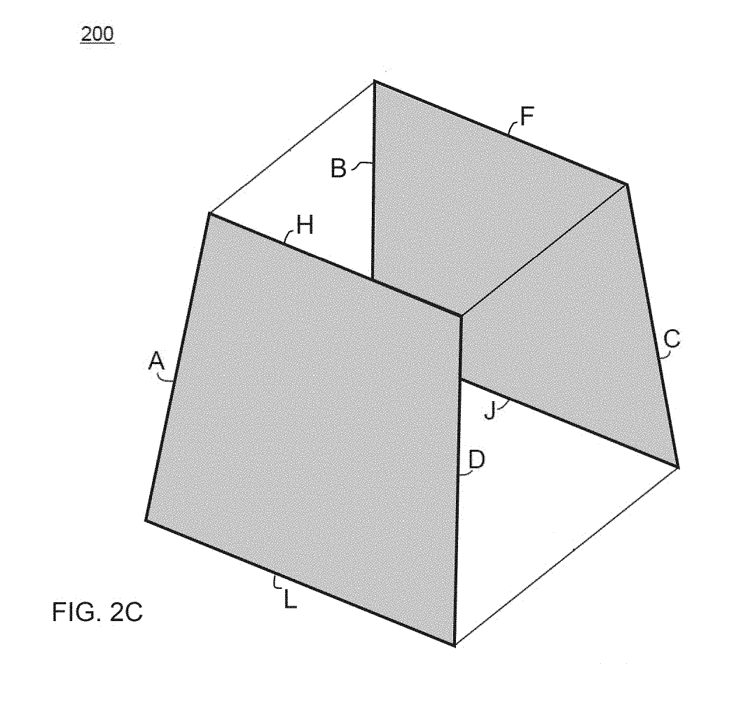

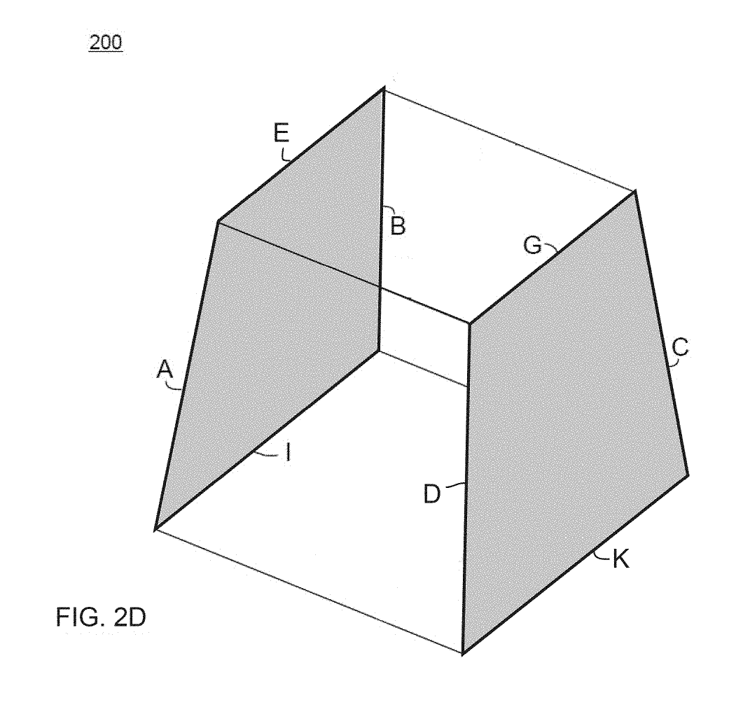

FIG. 2A is a reference frustum 200. Table 1 presents associated dimensions of the illustrated frustum.

TABLE 1
Reference Frustum Dimensions - Length

| Reference | Length |
|---|---|
| a | about 8″ to 20″ |
| b | about 8″ to 20″ |
| c | about 8″ to 20″ |
| d | about 8″ to 20″ |
| e | about 8″ to 20″ |

The reference frustum 200 may also be described herein as a truncated four-sided pyramid. The frustum 200 will have a rectangular footprint or a square footprint.

FIG. 2B is the reference frustum of FIG. 2A with reference labels identifying each edge of the frustum. Table 2 presents associated angles of the reference frustum.

TABLE 2
Reference Frustum Dimensions - Angles

| Ref. | Angle | Ref. | Angle |
|---|---|---|---|
| A-E | about 100°-130° | B-E | about 100°-130° |
| A-H | about 95°-130° | B-F | about 95°-130° |
| A-I | about 50°-85° | B-I | about 50°-85° |
| A-L | about 50°-85° | B-J | about 50°-85° |
| C-F | about 95°-130° | D-G | about 100°-130° |
| C-G | about 100°-130° | D-H | about 95°-130° |
| C-J | about 50°-85° | D-K | about 50°-85° |
| C-K | about 50°-85° | D-L | about 50°-85° |
| E-F | about 90° | I-J | about 90° |
| F-G | about 90° | J-K | about 90° |
| G-H | about 90° | K-L | about 90° |
| H-E | about 90° | L-I | about 90° |

In the reference frustum 200, a first planar side AHDL and a third planar side BFCJ each have a first trapezoidal perimeter. A second planar side CGDK and a fourth planar side BEAI each has a second trapezoidal perimeter. To improve clarity, FIGS. 2C and 2D are presented. FIG. 2C is the reference frustum of FIG. 2A with the first and third sides emphasized, and FIG. 2D is the reference frustum of FIG. 2A with the second and fourth sides emphasized;

A planar top EFGH of the reference frustum 200 forms a first rectangular perimeter, and a planar bottom IJKL forms a second rectangular perimeter. In some embodiments, each side of the first rectangular perimeter is shorter than a corresponding side of the second rectangular perimeter. In some embodiments, each side of the first rectangular perimeter is substantially the same length as a corresponding side of the second rectangular perimeter.

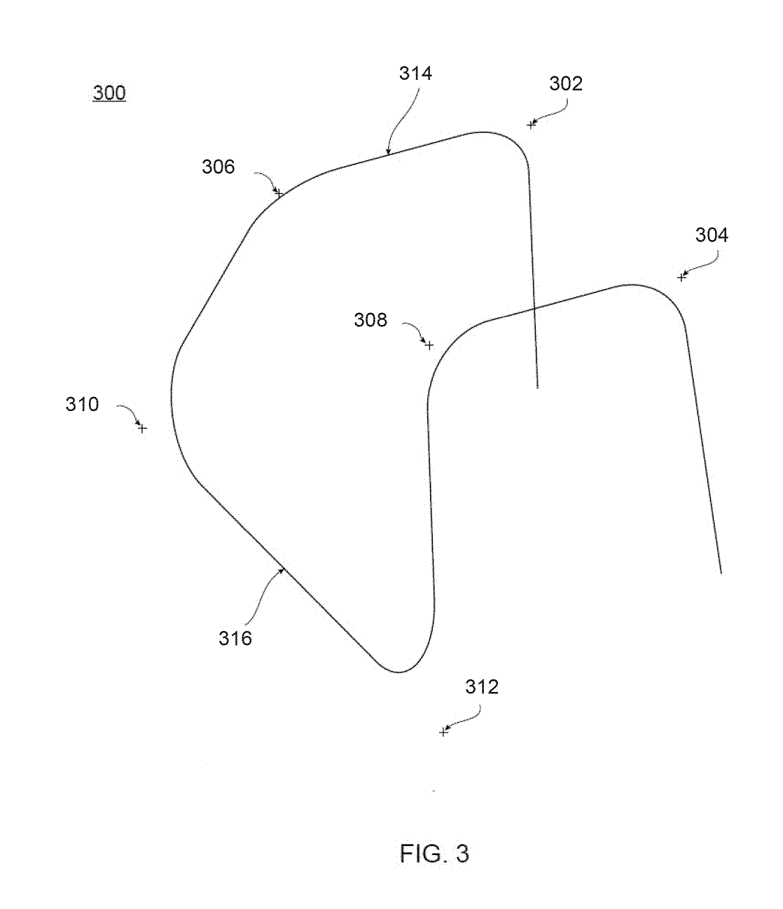

FIG. 3 illustrates a centerline 300 of the support structure 100 embodiment illustrated in FIG. 1. The support structure 100 may be formed from tubular material, square material, or a material having some other shape, form, or profile. The support structure may be substantially hollow, substantially solid, or completely solid. In some embodiments, the support structure 100 is formed from a metal such as steel (e.g., stainless steel), aluminum, and platinum. In some embodiments, the support structure 100 is formed from a metal alloy such as an aluminum alloy. In still other embodiments, the support structure 100 is formed from a composite material; for example, a fiberglass material combined with other materials such as graphite, Kevlar, or wood. Some embodiments may also be formed from other nonmetallic materials such as wood, fiberglass, molded plastic, thermosetting plastics (e.g., epoxy), polyester resin, acrylic, and the like. In at least some part due to the range of shapes and materials that are considered for use in the support structure 100, the support structure can be described according to the centerline 300.

Also in FIG. 3, the centerline 300 is illustrated with particular rounded corners 302 to 312 and linear portions 314, 316. The radius of the rounded corners may range from about 0.5 inches to about 10 inches, but other radii are also contemplated.

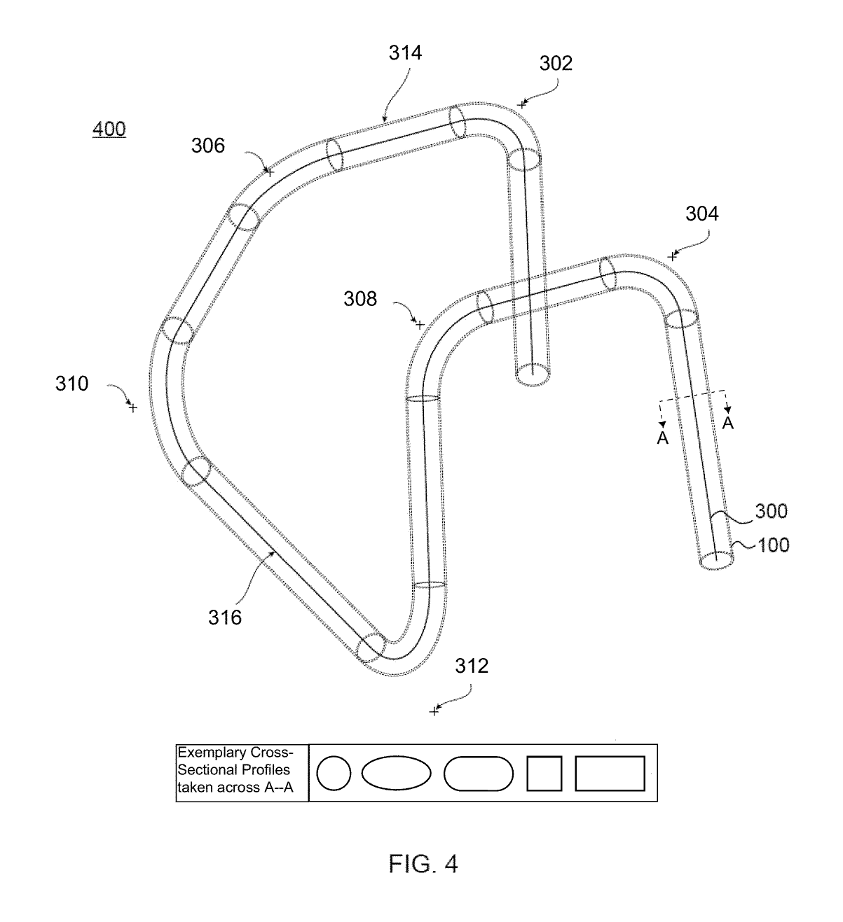

The support structure embodiment 400 of FIG. 4 illustrates the support structure 100 of FIG. 1 about the centerline 300 of FIG. 3. The rounded corners 302 to 312 and linear portions 314, 316 are illustrated for clarity. In the embodiment 400, the support structure 100 is shown in dashed lines to illustrate that centerline 300 is substantially at the geometric center of the tube that forms the support structure 100. In some embodiments, the support structure 100 is formed from a single tube. In other embodiments the support structure 100 is formed from a plurality of tube segments. In FIG. 4, several circular rings are illustrated as dashed lines to convey an understanding that the support structure 400 embodiment is formed from tubular material. Support structures having other cross-sectional shapes, including multiple cross-sectional shapes in the same structure, are also contemplated. In FIG. 4, a non-exhaustive representation of exemplary cross-sectional profiles taken across A-A includes a round cross-section, an oblong cross-section, an ovular cross-section, a square cross-section, and a rectangular cross-section.

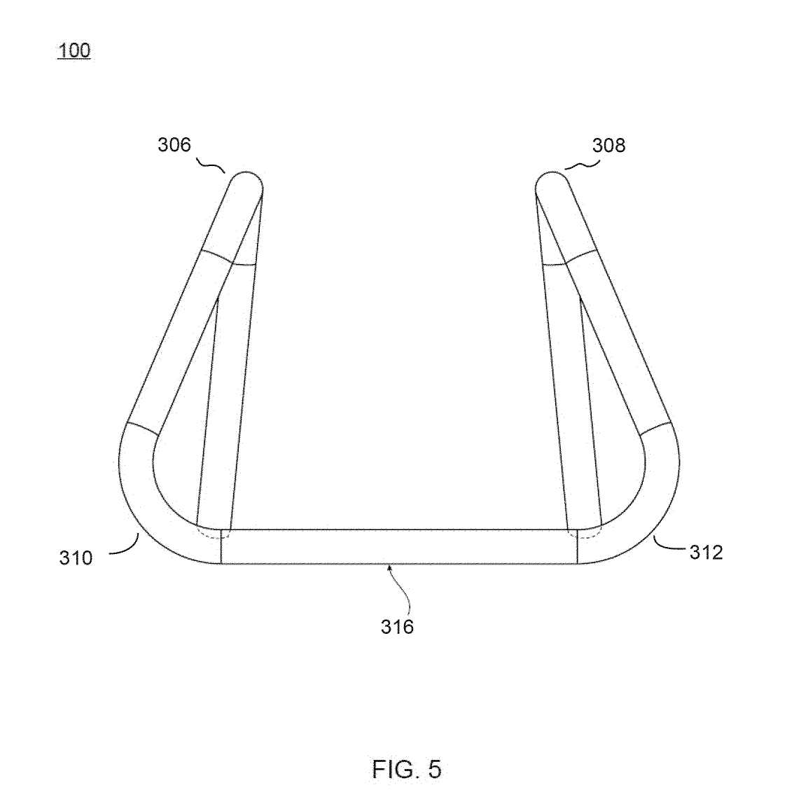

FIG. 5 is a front side view of the support structure 100 embodiment of FIG. 1. Rounded corners 306 to 312 and linear portion 316 are illustrated for clarity.

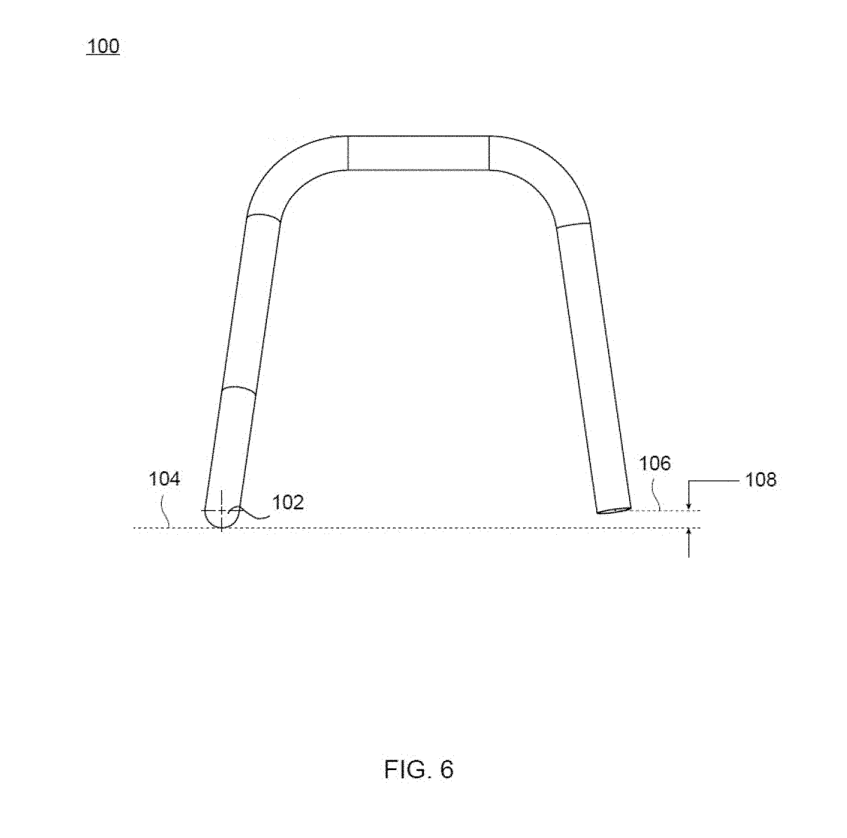

FIG. 6 is a right side view of the support structure 100 embodiment of FIG. 1. As illustrated in FIG. 6, a front side of support structure 100 is formed such that the tubular structure is bent to form a front, lower horizontal support member, which contacts the floor or the ground at a first level 104. Correspondingly, a second level 102 along the centerline 300 of the tube is represented in FIG. 6, along with a third level 106. The distance between the first level 104 and the second level 102 is represented as distance 108. The distance between the first level 104 and the third level 106 is also represented as distance 108. In some cases, distance 108 represents the radius of the tubular material that forms the support structure 100.

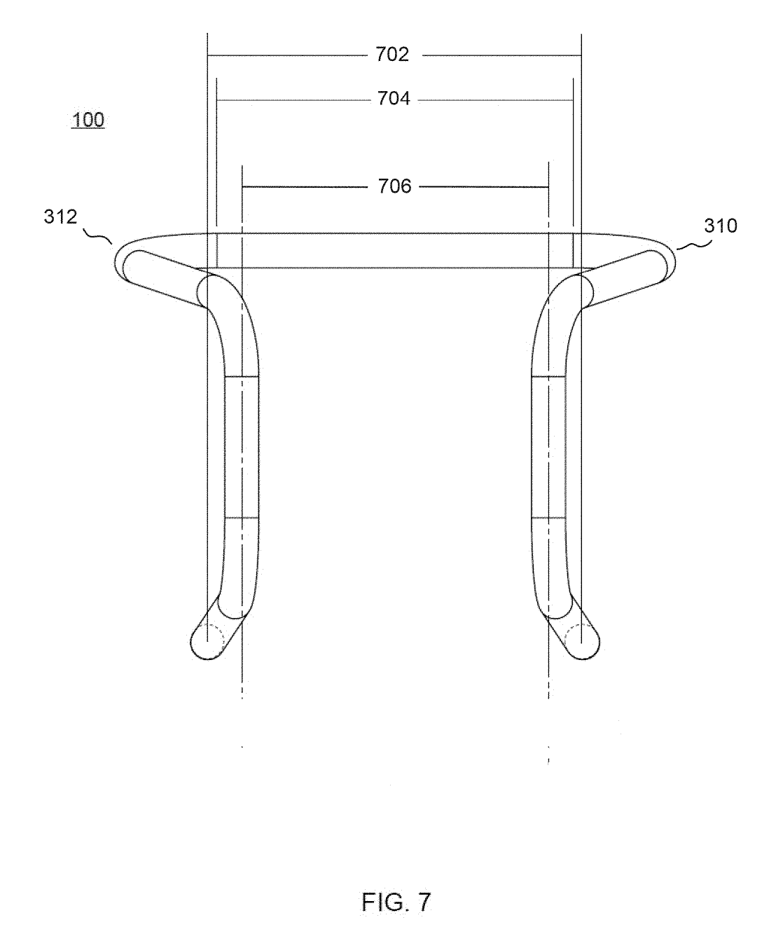

FIG. 7 is a top side view of the support structure 100 embodiment of FIG. 1. Particular rounded corners 310, 312 (FIGS. 3 and 4) along with certain measurements 702 to 706 are illustrated to further assist in understanding the support structure 100 embodiment. The measurements and the relationship between the measurements in FIG. 7 are non-limiting. Rather, measurements 702 to 706 illustrate desirable reference points for the embodiment. For example, measurement 702 may range from about 4 inches to about 20 inches. The length of measurement 702 is related to the size of the whole support structure embodiment 100. The length of measurement 702 is also related to the radius of particular corners 310, 312.

Measurement 704 may range from about 3 inches to about 19 inches. Measurement 704 corresponds to the length of edge L, the length of edge J, or the lengths edges L and J in the reference frustum 200 of FIG. 2B. The length of measurement 704 is related to the size of the whole support structure embodiment 100, the length of measurement 702, and certain ones of the angles of the support structure 100. Wth respect to the reference frustum 200 of FIGS. 2A-2D, the difference between measurements 702 and 704 illustrates that in some embodiments, the first planar side AHDL (FIG. 2C) and third planar side BFCJ (FIG. 2C) may have different lengths, different angles, or different lengths and different angles (i.e., different trapezoidal planes).

Measurement 706 may range from about 8 inches to 20 inches. Measurement 706 corresponds to the length of edge F, the length of edge H, or the lengths edges F and H in the reference frustum 200 of FIG. 2B.

FIG. 8 is a perspective view of the support structure 100 embodiment of FIG. 1 about the reference frustum 200 of FIG. 2A. Edges A, F, K, (FIG. 2B) and particular corner 312 (FIG. 3) are identified in FIG. 8 for clarity.

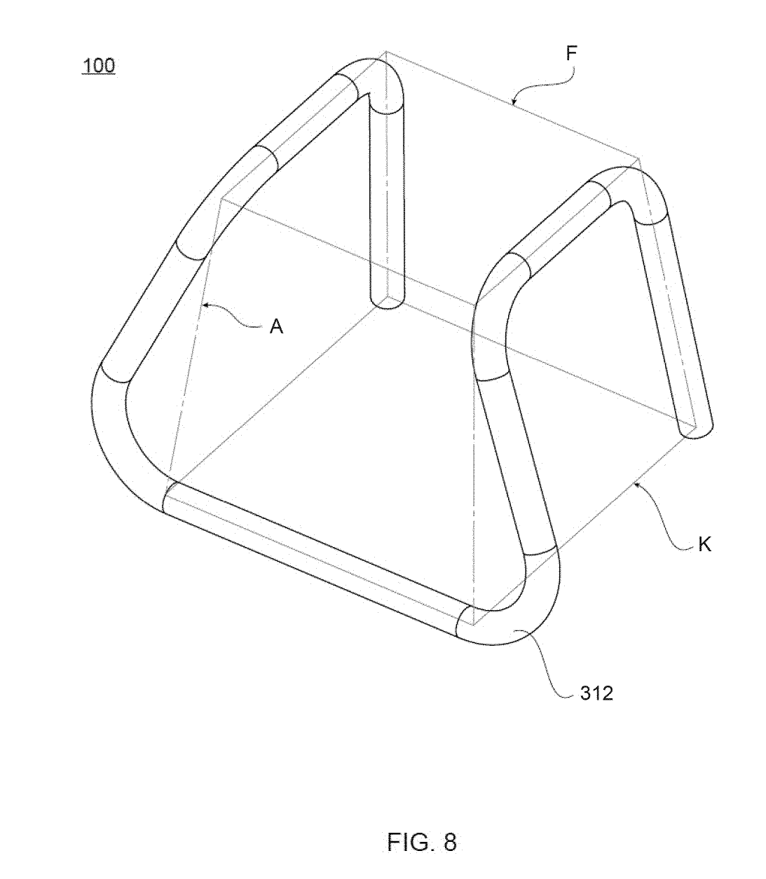

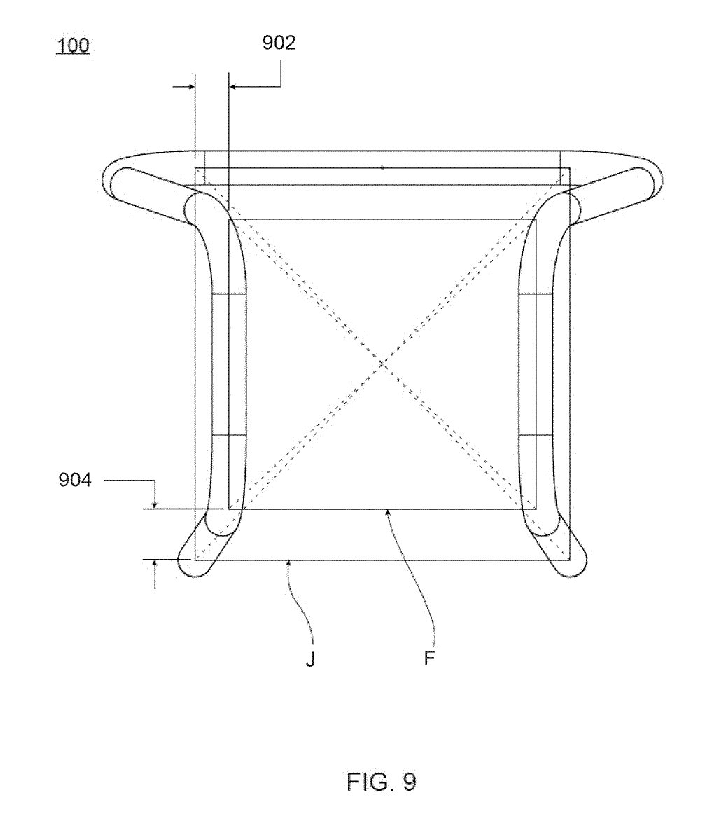

FIG. 9 is a top side view of the support 100 structure embodiment of FIG. 1 about the reference frustum 200 of FIG. 2A. Edges F and J (FIG. 2B) are identified in FIG. 8 for clarity. Measurement 902 in FIG. 9 illustrates the difference between measurements 702 and 706 (FIG. 7). Measurement 904 corresponds to about one half of the difference between the lengths of edges G and K (FIG. 2) and one half of the difference between the lengths edges E and I (FIG. 2). The difference between the lengths of edges G and K is substantially the same as the difference between the lengths of edges E and I.

In view of FIGS. 1, 2A to 2D, 8, and 9, the support structure 100 can be described by way of the reference frustum 200. Illustrated in FIGS. 8 and 9, the support structure 100 is formed about the reference frustum 200.

Prior to the formation, the support structure 100 may be formed as a straight length of tubular material, for example, thin-walled aluminum having an inside diameter of about 0.5 inches to about 2.0 inches. The straight length of tubular material may be about 50 inches to about 108 inches.

The support structure 100 begins at a point formed at the intersection of edges CJK (i.e., the lower right corner of second planar side CGDK (FIG. 2D)). Between the point of the support structure 100 formed at the intersection of edges CJK and a first bend in the support structure 100, a first vertical part of the support structure 100 corresponds to edge C. Edge C may be described as a first vertical part of support structure 100, which corresponds to a third edge (i.e., edge C) of the reference frustum 200 formed by the first planar side of the reference frustum 200 and the second planar side of the reference frustum 200.

The first bend in the support structure 100 along edges CG forms a first angle. A second bend in the support structure 100 along edges DG forms a second angle. A substantially straight section of the support structure 100 forms a first horizontal support member between the first bend and the second bend. The first horizontal support member may otherwise be described as corresponding to a first edge (i.e., edge G) of the reference frustum 200 formed by the first planar side of the reference frustum 200 and the planar top of the reference frustum 200.

A third bend in the support structure 100 along edges DL forms a third angle, and a fourth bend along edges AL forms a fourth angle. A substantially straight section of the support structure 100 forms a lower horizontal support member (i.e., edge L). As illustrated in FIG. 8, ground or floor contact points are formed at the lower part of the reference frustum 200. In some optional embodiments, the section formed as the lower horizontal support member is not substantially straight. Instead, in such optional embodiments, the lower horizontal support member has an arch with a particular radius of about 8 inches to about 8 feet or more.

The third bend and fourth bend of the support structure have a particular radius. The radius may be directed by the diameter of the tubular material. Accordingly, as illustrated in FIG. 8, some portions of the support structure 100 may be slightly exceed or impede the boundaries of the reference frustum 200. It is understood that the support structure 100 is still described as being formed about the reference frustum 200. When a person is using the support structure, the weight of the person is substantially distributed along the edges of the reference frustum 200.

Second and third vertical parts of the support structure 100 correspond, respectively to edges D and A. That is, the second vertical support structure is formed between the second bend and the third bend, and the third vertical support structure is formed between the third bend and a fourth bend. Edge D may be described as the second vertical part of the support structure 100, which corresponds to a fourth edge of the reference frustum 200 formed by the second planar side in the third planar side. Edge L may be described as the third vertical part of the support structure 100, which corresponds to a fifth edge of the reference frustum 200 formed by the third planar side and the fourth planar side of the reference frustum 200.

A fifth bend in the support structure 100 along edges AE forms a fifth angle, and a sixth bend along edges BE forms a sixth angle. Another substantially straight section of the support structure 100 forms a second horizontal support member (i.e., edge E) between the fifth bend and the sixth bend. The second horizontal support member may otherwise be described as corresponding to a second edge of the reference frustum 200 formed by the third planar side of the reference frustum 200 and the planar top of the reference frustum 200.

The support structure 100 terminates at a point formed at the intersection of edges BIJ. Between the point of the support structure 100 formed at the intersection of edges BIJ and the sixth bend in the support structure 100 formed along edges BE, a fourth vertical part of the support structure 100 corresponds to edge B. Edge B may be described as a fourth vertical part of support structure 100, which corresponds to a sixth edge (i.e., edge B) of the reference frustum 200 formed by the fourth planar side of the reference frustum 200 and the first planar side of the reference frustum 200.

In some embodiments (not shown), an optional third horizontal support member is formed as part of the support structure 100. The optional third horizontal support member corresponds to a third edge of the reference frustum 200 formed by the fourth planar side of the reference frustum 200 and the planar top of the reference frustum 200. Wth respect to FIG. 2B, the optional third horizontal support member would be arranged along edge H.

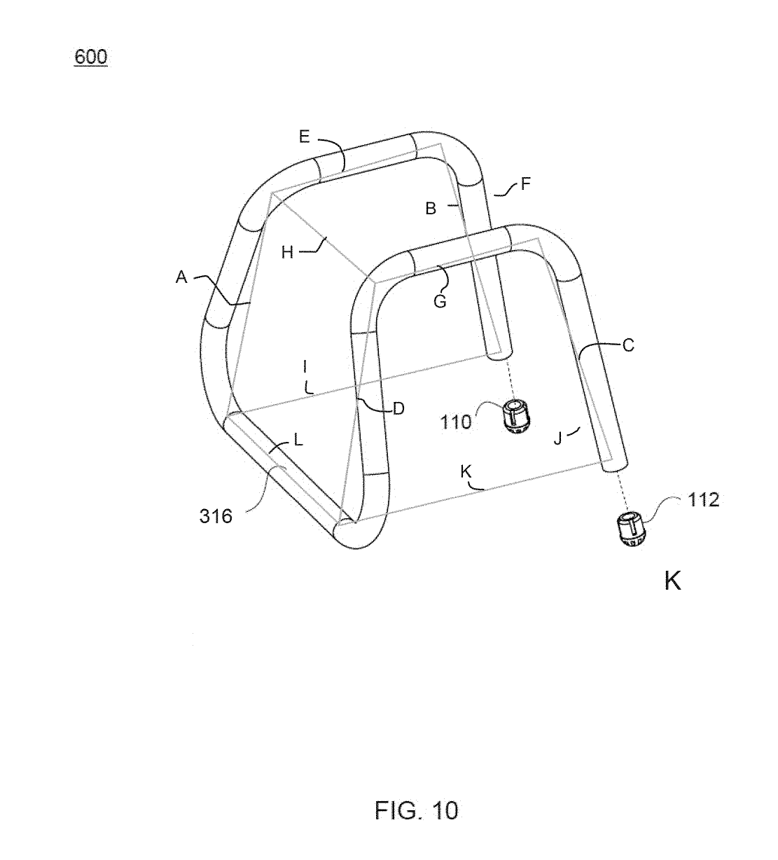

FIG. 10 is an exploded illustration 600 of the support structure 100 embodiment of FIG. 1 showing optional anti-skid material plugs 110, 112. The optional plugs 110, 112 may be made of any material. In some cases, the plugs 110, 112 are plastic, and in other cases, the plugs 110, 112 are wood, polyurethane, rubber, or some other material. The plugs 110, 112 terminate the two ends of the tubular material bent or otherwise arranged to form of the support structure 100. The plugs may be compression fit (e.g., friction fit) into the ends of the tubular material. Alternatively, or in addition, some type of locking mechanism may also be employed. Generally speaking, plugs 110, 112 are arranged to mate with the inside diameter of the tubular material.

Plugs 110, 112 may be formed such that a portion of the plugs extending out from the end of the tubular material corresponds to distance 108 (FIG. 6). In this way, the support structure 100 which may include plugs 110, 112, begins at a point of the reference frustum 200 corresponding to the intersection of edges CJK and ends at a point of the reference frustum 200 corresponding to the intersection of edges BIJ. Stated differently, the antiskid material is applied to each end of the tube wherein a first end of the tube corresponds to a left-most point of the reference frustum 200 formed by the first trapezoidal perimeter and the third trapezoidal perimeter and a second end of the tube corresponds to right-most point of the reference frustum 200 formed by the second trapezoidal perimeter and the third trapezoidal perimeter.

FIG. 11 is another embodiment of a support structure 100a, which is similar to the support structure 100 embodiment of FIG. 1 with optional anti-skid material plugs 110, 112 and optional handles 114 116. In some cases, the optional handles 114, 116 are identifiable features that may include decorations, visible markings, textured surfaces, or some combination thereof. The markings may include, for example, an illustration of a hand structure to visibly instruct or otherwise assist a user in the operation of the support structure. Alternatively, or in addition, the markings may include respective letters “R” and “L” to indicate where a person should place their right and left hands, arrows, contrasting colors, decorative colors, or some other visible features.

In some embodiments, the optional handles 114, 116 are textured surfaces (e.g., knurling, jeweling, beading, or the like) integrated with the horizontal support or otherwise attached thereto. The handles 114, 116 may be formed of rubber, plastic, or some other material selected for a desired comfort, friction, texture, or the like. In some other embodiments, the handles 114, 116 may have anatomically correct features to compliment a right hand, a left hand, or either hand. The handles 114, 116 may include other shaped features to assist a user in correct and safe operation of the support structure 100a such as bumps, protrusion, bulges, bulbs, knobs, protuberances, hollows, depressions, valleys, or the like. The handles 114, 116 may include other features such as a plurality of apertures, perforations, holes, slits, or the like to pass moisture from a hand and thereby facilitate useful friction. In some cases, the textured or otherwise shaped handles 114, 116 also include visible features described herein, for example, the decoration and visible marking “R” and “L” signifying, respectively, where on the anatomically complimentary structure a user should place their right hand and left hand.

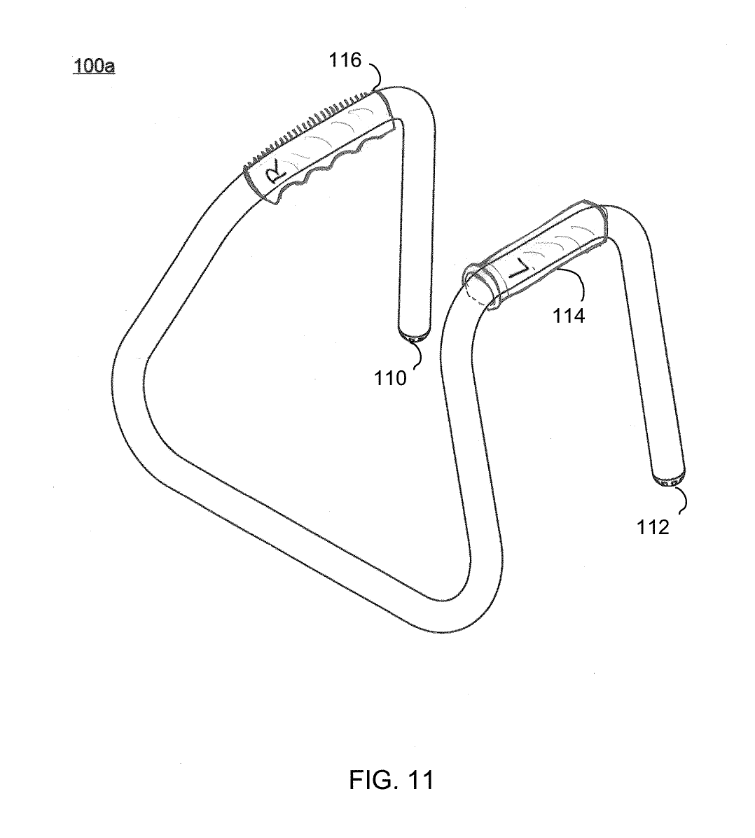

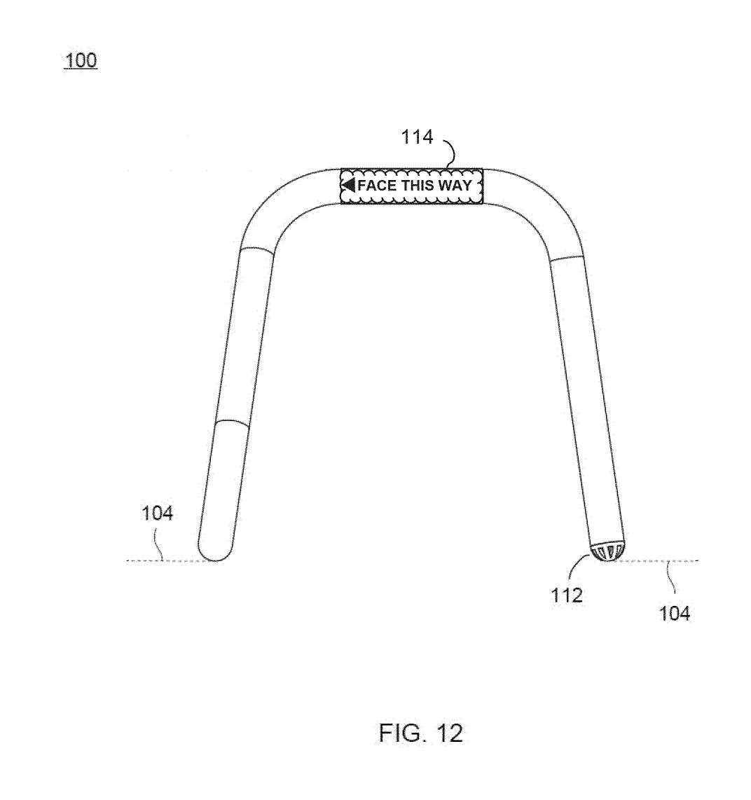

FIG. 12 is a right side view of the support structure 100 embodiment of FIG. 1. One optional anti-skid material plug 112 is illustrated in FIG. 12. One optional handle feature 114 is illustrated in FIG. 12. The handle feature 114 is a visible marking, which may be decorative and which may or may not be textured. The handle feature 114 in FIG. 12 visibly instruct or otherwise assist a user in the operation of the support structure 100.

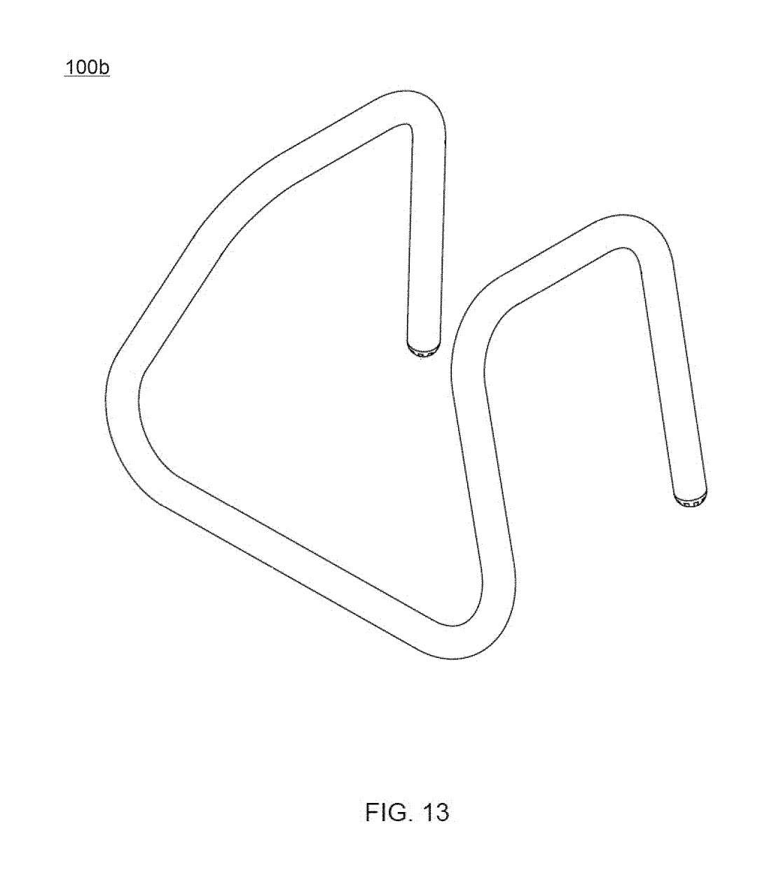

FIG. 13 is a perspective view of another support structure 100b embodiment. The support structure 100b of FIG. 13 bears similarity to the support structure 100 and support structure 100a of other figures in the disclosure. The embodiment of FIG. 13 clearly illustrates a support structure 100b formed from a single piece of material. The material may begin straight, such as a tube of thin-walled aluminum. Alternatively, the support structure 100b may be molded, poured, extruded, machine, or otherwise formed into a shape that substantially follows a reference frustum as discussed herein.

In some cases, support structures 100, 100a, and 100b are identical to each other. In other cases, support structures 100, 100a, and 100b are formed as a plurality of straight and curved segments which are assembled into shape as illustrated and described. Optionally, one or more couplings of the straight and curved segments are joined at one or more points. One or more of the points may be illustrated in, for example, as the substantially orthogonal lines across the tubular material of support structure 100. In some cases, the couplings are fixed and immovable. In some cases, the couplings are permitted to rotate fully or partially. In cases where the couplings are permitted to rotate fully or partially, the support structure may be manipulated (e.g., folded) for easier transportability.

Optionally, padding may be added to the first and second horizontal support members (i.e., along edges E and G, respectively; FIG. 2). The padding may cover a portion of the horizontal support members or the padding may cover the entire length of the horizontal support members. The padding may be rubber, plastic, cloth, or some other material. The padding may have anti-slip properties. The optional padding may be implemented as handles 114, 116 (FIGS. 11, 12).

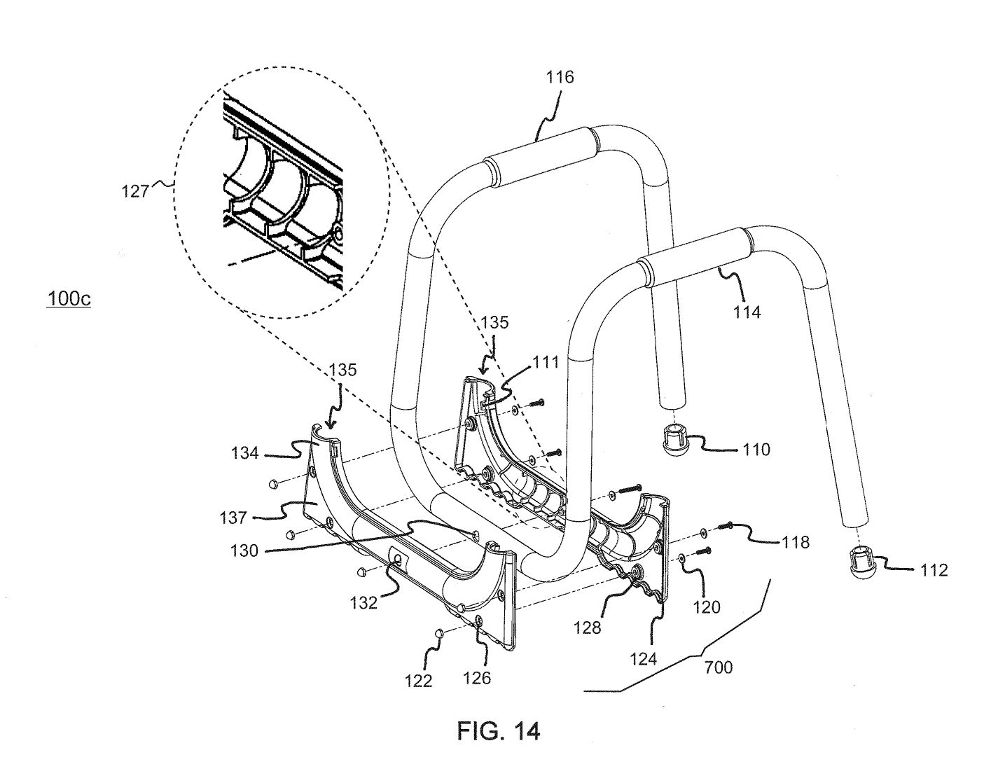

FIG. 14 is an exploded perspective view of another embodiment of a support structure with an optional anti-skid/anti-tip structure 100c. The support structure 100c of FIG. 14 is along the lines of support structures 100 and 100a of other figures in the disclosure. The anti-skid/anti-tip structure 700 is optional. The anti-skid/anti-tip structure 700 is arranged to reduce the likelihood of rolling, slipping, tipping, sliding, and the like, or even to prevent such rolling, slipping, tipping, and sliding of the support structure 100c while a person raises his or her body off of a floor ground, or other surface. The optional anti-skid/anti-tip structure 700 is important in some cases, and particularly when the person using the support structure 100c has at least one debilitated joint (e.g., artificial knee, artificial hip, or the like). Attaching the optional anti-skid/anti-tip structure 700 to the support structure 100c allows the person to stand up very quickly and efficiently without the worry of rolling, slipping, tipping, sliding, or some other undesirable motion of the support structure 100c.

The optional anti-skid/anti-tip structure 700 may be made of any suitable material. In some cases, the optional anti-skid/anti-tip structure 700 may be made of plastic, and in other cases, the optional anti-skid/anti-tip structure 700 may be made of wood, polyurethane, rubber, metal, or some other material or combination of materials. The optional anti-skid/anti-tip structure 700 may be formed by injection molding, compression molding, milling, or by some other formation technique. Furthermore, the optional anti-skid/anti-tip structure 700 may be a single piece or may be formed of multiple parts.

In this embodiment of FIG. 14, the optional anti-skid/anti-tip structure 700 includes multiple parts. More specifically, the optional anti-skid/anti-tip structure 700 includes a first half 124 and a second half 134. Each of the first half 124 and second half 134 may be about the same size in some embodiments. In other embodiments, each of the first half 124 and second half 134 are differently sized portions of the anti-skid/anti-tip structure 700. In some cases, the anti-skid/anti-tip structure will have more than two portions. Nevertheless, for ease of understanding the drawings and concepts discussed herein, both the first half 124 and second half 134 are about the same size.

In the support structure 100c of FIG. 14, the first half 124 and the second half 134 are formed to each have an enclosure region 135 that cooperate to enclose a lower horizontal support member along edge L (FIG. 2C), a third bend along edges DL (FIG. 2C), and a fourth bend along edges AL (FIG. 2C) of the support structure. The enclosure region 135 follows a certain portion of the support structure and has a substantially similar shape as the certain portion of the support structure. In addition, the enclosure region 135 has a substantially similar cross-sectional shape as the support structure 100c or a cross-sectional shape that will enclose a portion of the support structure 100c.

In the embodiment of FIG. 14, the first half 124 and the second half 134 of the optional anti-skid/anti-tip structure 700 are formed to be substantially mirror images of each other. Forming the anti-skid/anti-tip structures in this way may provide benefits to manufacture, assembly, shipping, packaging, and the like. In other embodiments, the first half 124 and the second half 134 of the optional anti-skid/anti-tip structure 700 are formed having features that are different from each other.

In this embodiment of support structure 100c, the enclosure region 135 of the optional anti-skid/anti-tip structure 700 contains a plurality of ribs 127. The ribs 127 are illustrated in an enlarged portion of FIG. 14. The ribs 127 are arranged to form an acceptably tight fit around the lower horizontal support member L (FIG. 2C), the third bend DL (FIG. 2C), and the fourth bend AL (FIG. 2C) of the support structure 100c. The ribs 127 may be formed to provide strength, stability, mating surfaces, mounting surfaces, or for other reasons. In a cooperative coupling relationship, the ribs may cooperate with other features (e.g., tubular surfaces) in the support structure 100c to avoid movement of the optional anti-skid/anti-tip structure 700 about other portions of the support structure 100c.

In alternative embodiments, the enclosure region 135 may be formed to have one or more thicker dimensions. Such embodiments may be arranged to form a tight fit around the lower horizontal support member, the third bend, the fourth bend, or some other portion or portions of the support structure 100c. In addition, thicker material may add weight, greater surface area, or some other aspect to the optional anti-skid/anti-tip structure 700 to reduce or avoid movement between the optional anti-skid/anti-tip structure 700 and other portions of the support structure 100c. Additional size, weight, or other characteristics may be added to further reduce the likelihood of or even prevent rolling, slipping, tipping, sliding, and other undesirable motion of the optional anti-skid/anti-tip structure 700 and the support structure 100c.

In yet another alternative embodiment, the plurality of ribs 127 may be combined with another material to add weight to the optional anti-skid/anti-tip structure 700. For example, the space between ribs of the plurality of ribs may be filled with any material to add weight to the optional anti-skid/anti-tip structure 700 to further prevent rolling, tipping, slipping, sliding, and other undesirable motion of the optional anti-skid/anti-tip structure 700 and the support structure 100c.

In the embodiment of FIG. 14, each of the first half 124 and the second half 134 of the optional anti-skid/anti-tip structure 700 has anti-skid/anti-tip “wings” 137. The anti-skid/anti-tip wings 137 are formed along the enclosure region 135 where anti-skid/anti-tip structure 700 encloses and corresponds to the third bend AL (FIG. 2C) and the fourth bend DL (FIG. 2C) of the support structure 100c. Each of the first half 124 and the second half 134 of the optional anti-skid/anti-tip structure 700 is arranged with a portion of the anti-skid/anti-tip wings 137 in the support structure 100c. In other embodiments, one of the first half 124 and second half 134 has one wing, and the other of the first half 124 and second half 134 has the other wing. In still other embodiments, each of the first half 124 and second half 134 has an upper or a lower half of a wing. Still other anti-skid/anti-tip wings 137 embodiments have been contemplated.

When the support structure 100c is in use, the anti-skid/anti-tip wings 137 of the first half 124 and the second half 134 are formed to contact the floor, the ground, or another surface where the support structure 100 is in use. Each anti-skid/anti-tip wing 137 extends from an opposing end of the enclosure region 135 and encloses one of the third bend AL (FIG. 2C) and the fourth bend DL (FIG. 2C) of the support structure 100c. In the embodiment of FIG. 14, the anti-skid/anti-tip wings 137 include two straight sections that come together to form a corner. The first and second straight sections are connected by a curved section along the enclosure region 135 of the first half 124 and the second half 134 of the optional anti-skid/anti-tip structure 700. The curved section is where the enclosure region 135 and the anti-skid/anti-tip wings 137 come together to form the optional anti-skid/anti-tip structure 700. The curved sections of the anti-skid/anti-tip wings 137 correspond to the third bend AL (FIG. 2C) and the fourth bend DL (FIG. 2C) of the support structure 100c. Also, one of the straight sections of the two straight sections is a base and the other straight section is a side.

The anti-skid/anti-tip wings 137 of the first and second halves 124, 134 include a plurality of first coupling locations 126, 128. In one or more alternative embodiments, the plurality of first coupling locations 126, 128 may be formed along the enclosure region 135 of the first half 124 and the second half 134 of the optional anti-skid/anti-tip structure 700 or at one or more other locations of the optional anti-skid/anti-tip structure 700. The plurality of first coupling locations 126, 128 may be formed to accept a plurality of fasteners, a plurality of locking mechanisms, or any other coupling structures or combination thereof. The coupling structures may be arranged to couple the optional anti-skid/anti-tip structure 700 to the support structure 100c. In addition, or in the alternative, the coupling structures may be arranged to couple the first half 124 to the second half 134.

In the embodiment of FIG. 14, the plurality of first coupling locations 126, 128 are formed to allow coupling components 118, 120, 122 to couple the optional anti-skid/anti-tip structure 700 to the support structure. The coupling components include pluralities of a bolt 118, a washer 120, and a nut 122 that couple the optional anti-skid/anti-tip structure 700 at each of the plurality of first coupling locations 126, 128. In alternative embodiments, the plurality of first coupling locations 126, 128 may be formed to utilize another locking mechanism such as a press-fit connection, a force-fit connection, or some other locking mechanism or coupling technique. In other alternative embodiments, the plurality of first coupling locations 126, 128 may be formed to utilize any combination of locking mechanisms (e.g., force-fit, press-fit) or coupling techniques (e.g., fastener sets such as screws, washers, and nuts, rivets, glue, adhesive, hook-and-loop, and the like) to couple the optional anti-skid/anti-tip structure 700 to the support structure 100c.

In the embodiment of FIG. 14, a coupling mechanism 111 along the enclosure region 135 assists a mating of the first half 124 to the second half 134 during assembly of the optional anti-skid/anti-tip structure 700. In this embodiment, the coupling mechanism 111 is utilized in combination with the coupling components 118, 120, 122 of the anti-skid/anti-tip wings 137, however, in other embodiments, the coupling mechanism 111 is used instead of the coupling components 118, 120, 122.

The coupling mechanism 111 includes male and female connector portions. The coupling mechanism 111 of support structure 100c has been formed along an edge of the enclosure region 135 of the first half 124 and the second half 134 corresponding to the fourth bend AL (FIG. 2C) of the support structure 100c. In alternative embodiments, however, any number of coupling mechanisms 111 may be formed on any part or location of the optional anti-skid/anti-tip structure 700. One or more coupling mechanisms 111 may be arranged to cooperate with coupling components, or coupling mechanisms 111 may be used alone to attach the anti-skid/anti-tip structure 700 to the support structure 100c. In at least some cases, structures along the lines of coupling mechanisms 111 may be referred to as cooperative coupling mechanisms.

In the embodiment of FIG. 14, support structure 100c includes a second coupling location 130, 132. The second coupling location 130, 132 is a fastener orifice, which may be round, square, or of one or more other shapes. In alternative embodiments, the enclosure region 135 and the lower horizontal support member L (FIG. 2C) may have a plurality of second coupling locations or no second coupling locations. Similar to the plurality of first coupling locations 126, 128, in this embodiment, the second coupling location 130, 132 is formed to allow for coupling components 118, 120, 122 to couple the optional anti-skid/anti-tip structure 700 about the support structure. In alternative embodiments, the second coupling location 130, 132 may be formed to utilize a coupling mechanism 111 such as a press-fit connection, a force-fit connection, or some other coupling mechanism or coupling technique to couple the optional anti-skid/anti-tip structure 700 to the support structure 100c.

The optional anti-skid/anti-tip structure 700 of FIG. 14 includes optional handles 114, 116 and optional anti-skid material plugs 110, 112. The optional anti-skid/anti-tip structure 700, the optional handles 114, 116, and the optional anti-skid material plugs 110, 112 may allow for the person with the debilitated or injured joint to easily use the support structure 100c safely with or without the supervision of another individual. Different embodiments of the support structure 100c include any one or more of the optional anti-skid/anti-tip structure 700, the optional handles 114, 116, and the optional anti-skid material plugs 110, 112.

Because of the optional anti-skid/anti-tip structure 700, the support structure 100c may be utilized on various terrains and surfaces. For example, the support structure 100c having the optional anti-skid/anti-tip structure 700 may be utilized on flat surfaces, uneven surfaces, angled surfaces, or other surfaces that would otherwise increase the likelihood of rolling, slipping, tipping, sliding, and other undesirable motion. In addition, the optional anti-skid/anti-tip structure 700 may be made of materials resistant to one or more environmental conditions such as water, chemicals, heat, sharp objects, and the like. Accordingly, selection of appropriate materials may permit the support structure 100c to be used in an outside environment where external stresses and factors exist. For example, outside environments may be a yard, a park, a garden, a boat, or any place exposed to external stresses and factors. In addition, for example, external stresses and factors may be rain, snow, sun, external motion, or other external stresses or factors that occur in a particular environment such as an outside environment.

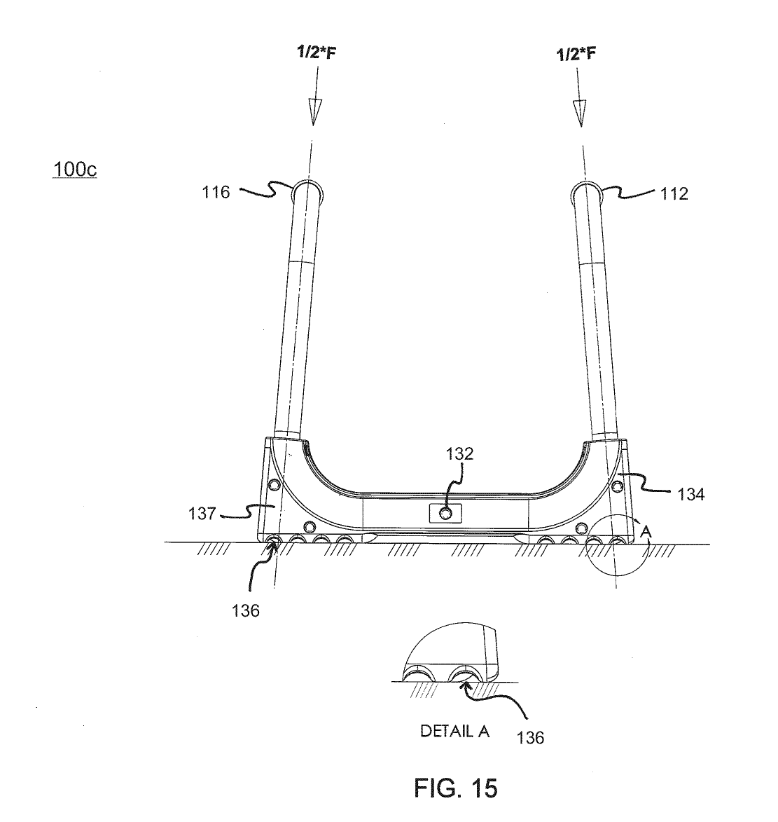

FIG. 15 is a front side view of the support structure 100c with the optional anti-skid/anti-tip structure 700 embodiment of FIG. 14. The optional anti-skid/anti-tip structure 700 includes anti-skid/anti-tip components 136. To assist an understanding of FIG. 15, one embodiment of anti-skid/anti-tip components 136 is shown enlarged in Detail A.

In this embodiment of FIG. 15, the anti-skid/anti-tip components 136 are formed at a base of a first half 124 and a second half 134 of the optional anti-skid/anti-tip structure 700. More specifically, the anti-skid/anti-tip components 136 are located at the respective bases of the right and left anti-skid/anti-tip wings 137. In alternative embodiments, however, the anti-skid/anti-tip components 136 may be formed along any length and in any location of the optional anti-skid/anti-tip structure 700.

The anti-skid/anti-tip components 136 in FIG. 15 are a plurality of half ellipses that extend through the base of the first half 124 and the second half 134 of the optional anti-skid/anti-tip structure 700. The plurality of half ellipses forms multiple contact points between the optional anti-skid/anti-tip structure and a floor, a ground, or another surface where the support structure 100c is in use. Although the anti-skid/anti-tip components 136 of support structure 100c are a plurality of half ellipses, the anti-skid/anti-tip components may be of any shape, size, or shape and size. For example, the anti-skid/anti-tip components may be rectangles, trapezoids, or any other shapes or combinations of shapes. In addition, or in alternative embodiments, the anti-skid/anti-tip components 136 may include one or more strips of anti-skid material placed along the base of the optional anti-skid/anti-tip structure 700. Also, in these or in still other alternative embodiments, the anti-skid/anti-tip components 136 may be formed along the entirety of the base of the optional anti-skid/anti-tip structure 700.

In this embodiment of FIG. 15, the anti-skid/anti-tip components 136 are made of the same material as the optional anti-skid/anti-tip structure 700. In alternative embodiments, however, the anti-skid/anti-tip components 136 may be made of any one or more same or different materials than the optional anti-skid/anti-tip structure 700.

In the support structure 100c embodiment, direction of force arrows and reference characters (i.e., ½*F) show that in a desirable method of use, one half of the force applied by a person using the support structure 100c is passed through a first (e.g., left) side of the support structure 100c, and one half of the force applied by the person using the support structure 100c is passed through a second (e.g., right) side of the support structure 100c. This configuration would be present when a person is supporting some portion of their body weight centered above the support structure 100c. It is recognized that prior to centering their weight over the support structure 100c, the person using the support structure 100c may first place some or all of their weight on one side of the support structure 100c. In these cases, the presence of an optional anti-skid/anti-tip structure 700 may reduce or eliminate the chance that the support structure 100c will tip or otherwise become unstable.

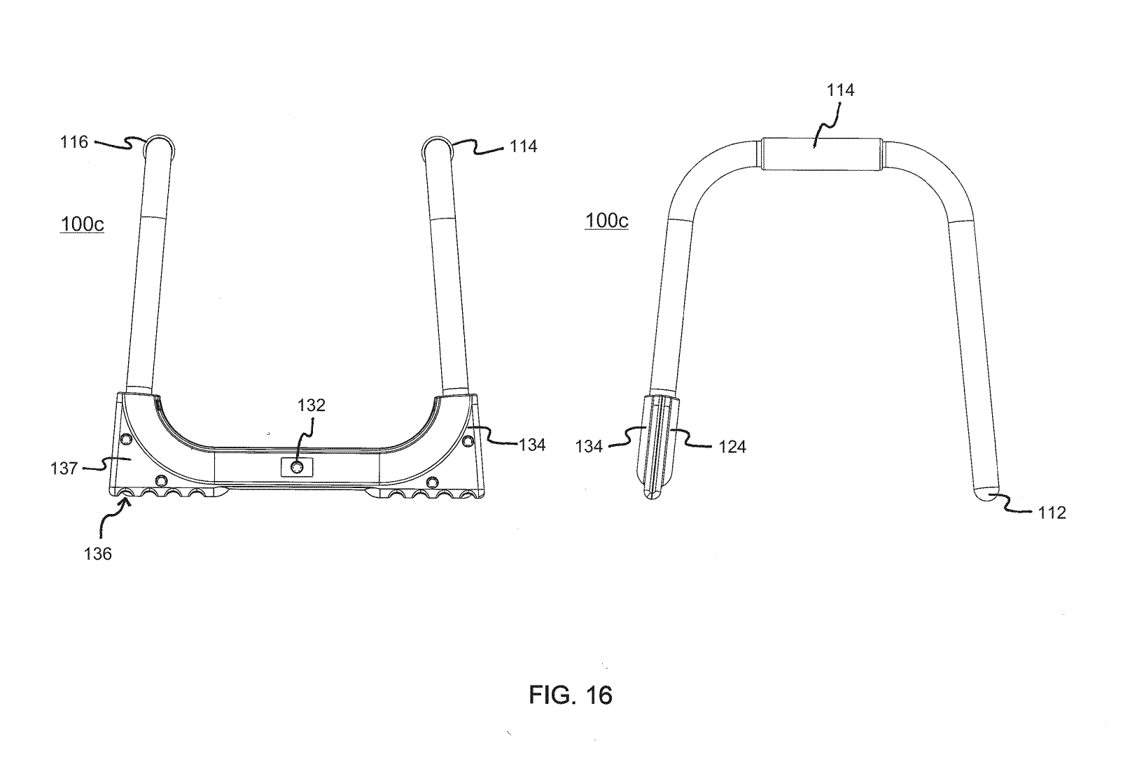

FIG. 16 is a front side view and a right side view of the support structure 100c with the optional anti-skid/anti-tip structure 700 embodiment of FIG. 14.

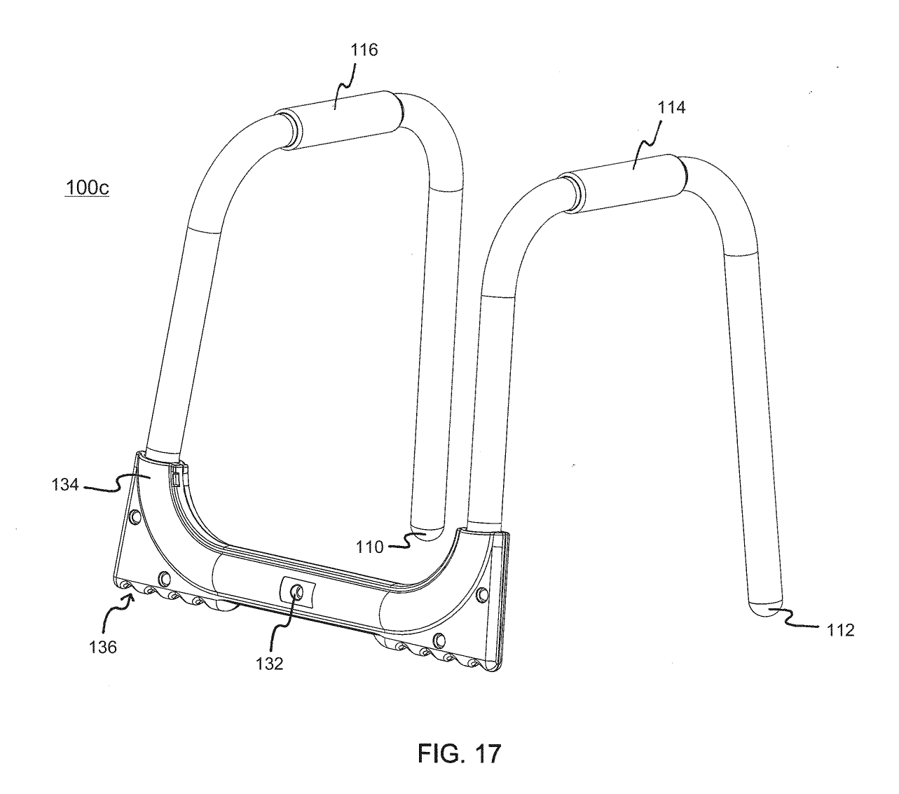

FIG. 17 is a non-exploded isometric view of the support structure 100c with the optional anti-skid/anti-tip structure 700 embodiment of FIG. 14.

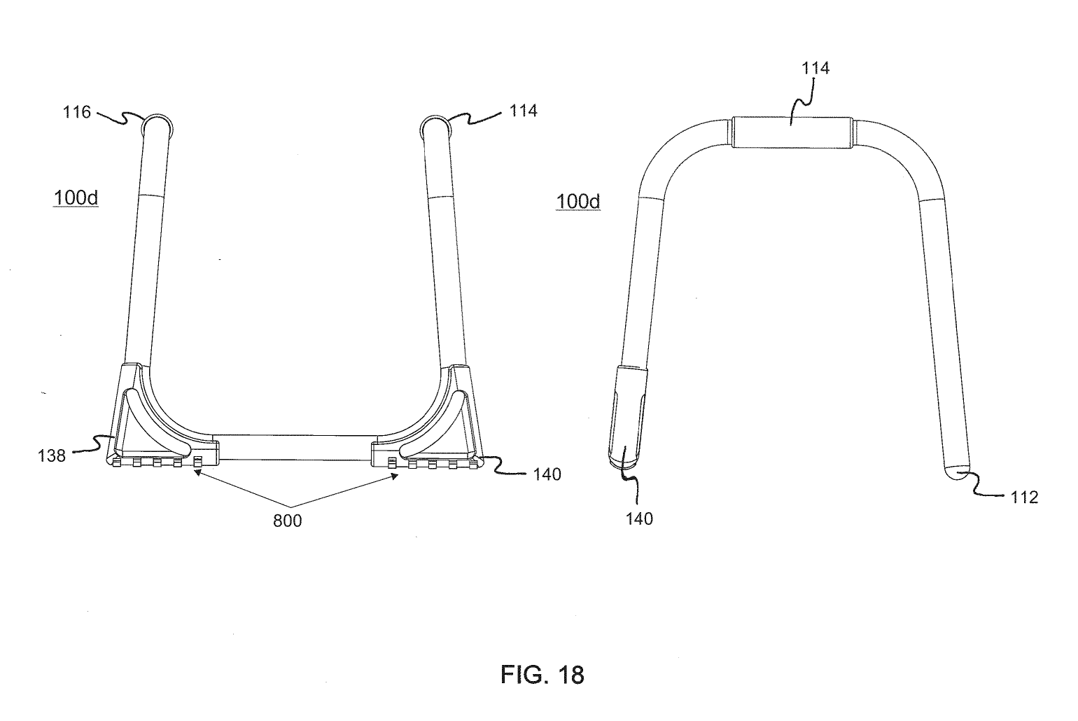

FIG. 18 is a front side view and a right side view of another embodiment of a support structure 100d, which is along the lines of embodiments represented in FIGS. 1-13 and FIGS. 14-17, and which includes optional anti-skid/anti-tip structures 800. The optional anti-skid/anti-tip structures 800 cooperate with a third bend along edges AL (FIG. 2C) of the support structure 100d and with a fourth bend along edges DL (FIG. 2C) of the support structure 100d.

The optional anti-skid/anti-tip structures 800 may be made of any material. In some cases, the optional anti-skid/anti-tip structures 800 may be made of plastic, and in other cases, the optional anti-skid/anti-tip structures 800 may be made of wood, polyurethane, rubber, metal, or some other material or combination of materials. The optional anti-skid/anti-tip structures 800 may be formed by injection molding, compression molding, milling, or by some other formation technique.

In this embodiment of FIG. 18, the optional anti-skid/anti-tip structures 800 are hollow. In alternative embodiments, however, the optional anti-skid/anti-tip structures 800 may be solid, ribbed, or arranged according to some other structure.

The optional anti-skid/anti-tip structures 800 include a first optional anti-skid/anti-tip structure 138 that corresponds to the third bend AL (FIG. 2C) of the support structure, and a second optional anti-skid/anti-tip structure 140 that corresponds to the fourth bend DL (FIG. 2C) of the support structure. The first and the second optional anti-skid/anti-tip structures 138, 140 are coupled to the support structure by a coupling mechanism. In this case, the coupling mechanism is a force-fit or press-fit locking mechanism that surrounds the third bend AL and the fourth bend DL. In other cases, the coupling mechanism may be a plurality of coupling components, a glue, or some other coupling technique.

In this embodiment of FIG. 18, the support structure 100d also includes optional handles 114, 116 and optional anti-skid material plugs 110, 112. In alternative embodiments, any combination of the optional anti-skid/anti-tip structures 800, the optional handles 114, 116, and the anti-skid material plugs 110, 112 may be used.

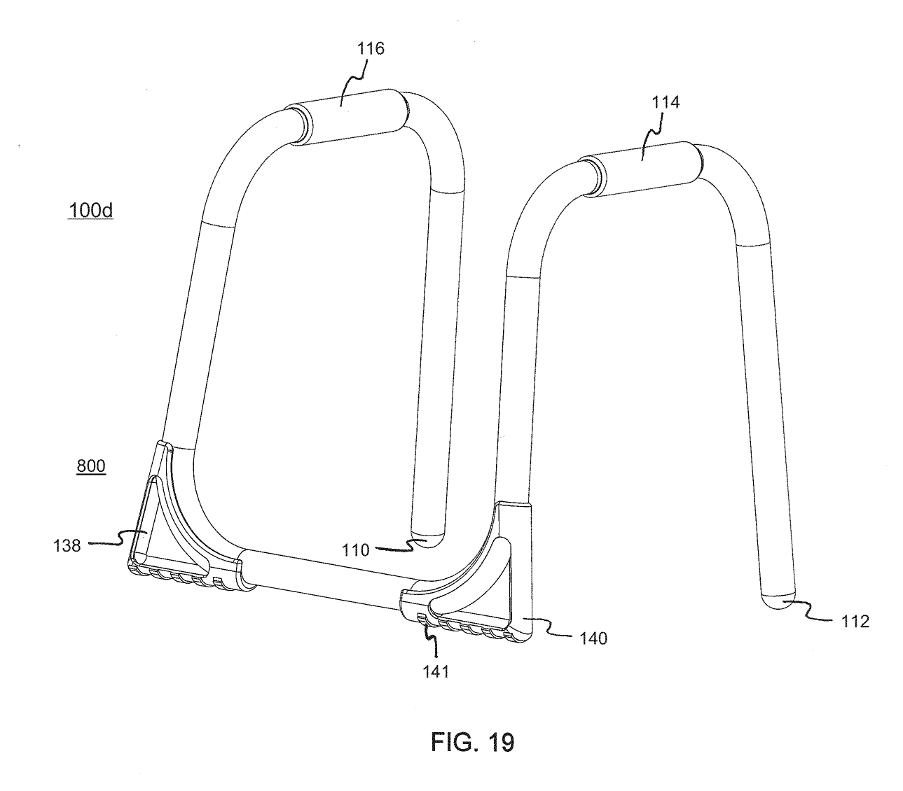

FIG. 19 is an isometric view of the support structure embodiment with the optional anti-skid/anti-tip structures 800 of FIG. 18. In this embodiment, the optional anti-skid/anti-tip structures 800 include anti-skid/anti-tip components 141. The anti-skid/anti-tip components 141 are formed as a plurality of rectangles along respective bases of the first and the second optional anti-skid/anti-tip structures 138, 140. In alternative embodiments, the anti-skid/anti-tip components 141 may be any shape or size. For example, the anti-skid/anti-tip components 141 may be shaped as ellipses, trapezoids, or any other shape or combination of shapes. In addition, in alternative embodiments, the anti-skid/anti-tip components 141 may include one or more portions of anti-skid material arranged on the base of each optional anti-skid/anti-tip structure 800. In addition, in alternative embodiments, the anti-skid/anti-tip components 141 may be formed along any length and in any location along the optional anti-skid/anti-tip structures 800.

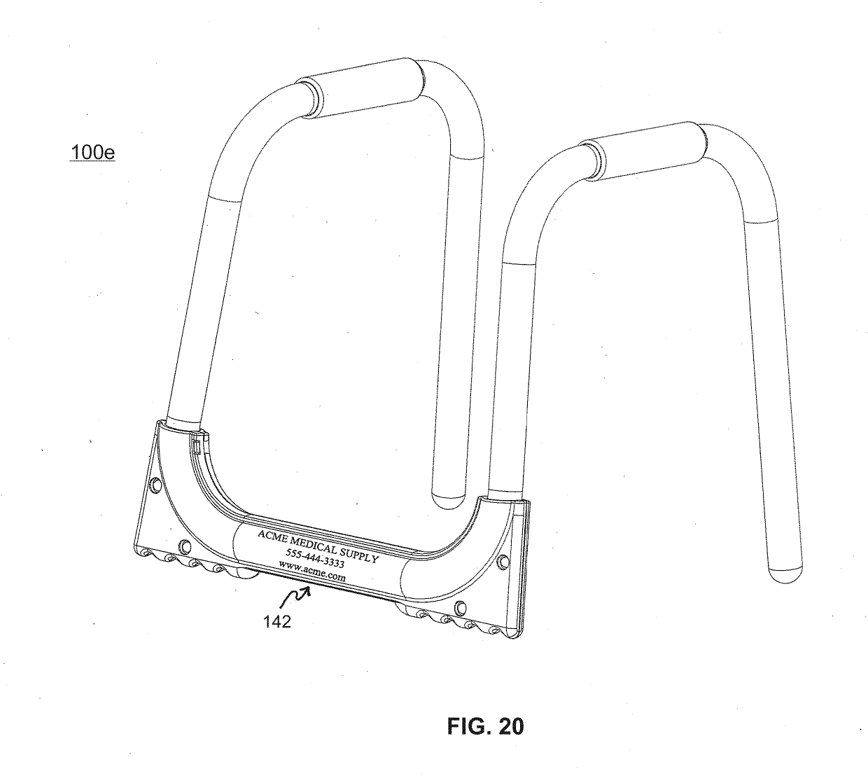

FIG. 20 is a perspective view of another embodiment of a support structure 100e with an optional anti-skid/anti-tip structure 700, which is similar to the support structure 100c embodiment of FIGS. 14-17.

In this embodiment of support structure 100e, the optional anti-skid/anti-tip structure 700 has at least one identifiable feature 142. The identifiable feature 142 is located on an external portion of an enclosure region 135 that surrounds and corresponds to a lower horizontal support member of the support structure 100e. In alternative embodiments, the identifiable feature 142 may be located anywhere on the optional anti-skid/anti-tip structure 700 or in some other part of the support structure 100e.

The identifiable feature 142 may be a decoration, a visible marking, a textured surface, an anatomically complimentary structure, or any combination thereof, or some other identifiable feature. In some cases, the identifiable feature 142 is arranged to indicate who produced, manufactured, or sold the optional anti-skid/anti-tip structure 700, the support structure 100e, or both the optional anti-skid/anti-tip structure 700, the support structure 100e. In other cases, the identifiable feature 142 may include advertising, instructions for use, a bar code, or some other human or machine readable information. Furthermore, the identifiable feature 142 may include customer service and support information. In alternative embodiments, the optional anti-skid/anti-tip structure 700 may have no identifiable features 142, two identifiable features 142, or any number of identifiable features 142. The identifiable feature 142 may include contact information such as a name, a phone number, an e-mail, a uniform resource locator (URL), or any other identifying information or contact information.

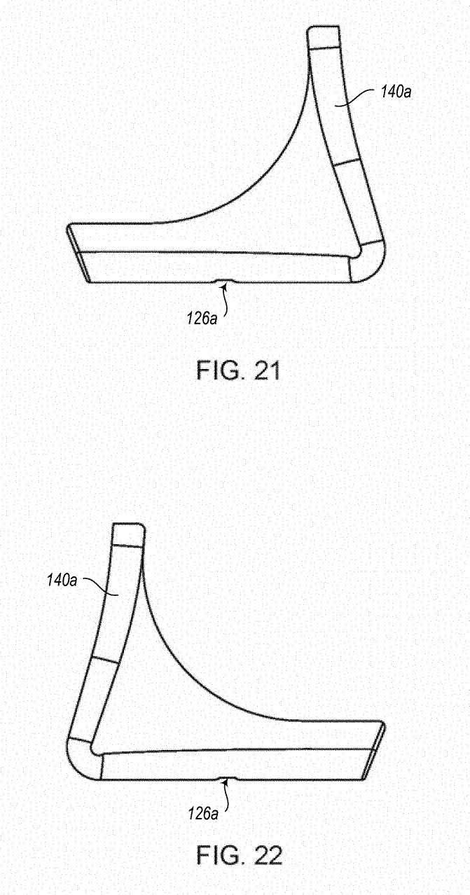

FIG. 21 is a front side view of another optional anti-skid/anti-tip component 140a, which is along the lines of the optional anti-skid/anti-tip components 138, 140 of the anti-skid/anti-tip structure 800 in FIG. 18.

FIG. 22 is a back side view of the optional anti-skid/anti-tip component 140a of FIG. 21.

In the embodiment of FIG. 21, the optional anti-skid/anti-tip component 140a may be made of any suitable material. In some cases, the optional anti-skid/anti-tip component 140a may be made of plastic, and in other cases, the optional anti-skid/anti-tip component 140a may be made of wood, polyurethane, rubber, metal or some other material or combination of materials. The optional anti-skid/anti-tip component 140a may be formed by injection molding, compression molding, milling, or by some other formation technique.

In some embodiments, the optional anti-skid/anti-tip component 140a is ribbed. In alternative embodiments, however, the optional anti-skid/anti-tip component 140a may be hollow, solid, or arranged according to some other structure.

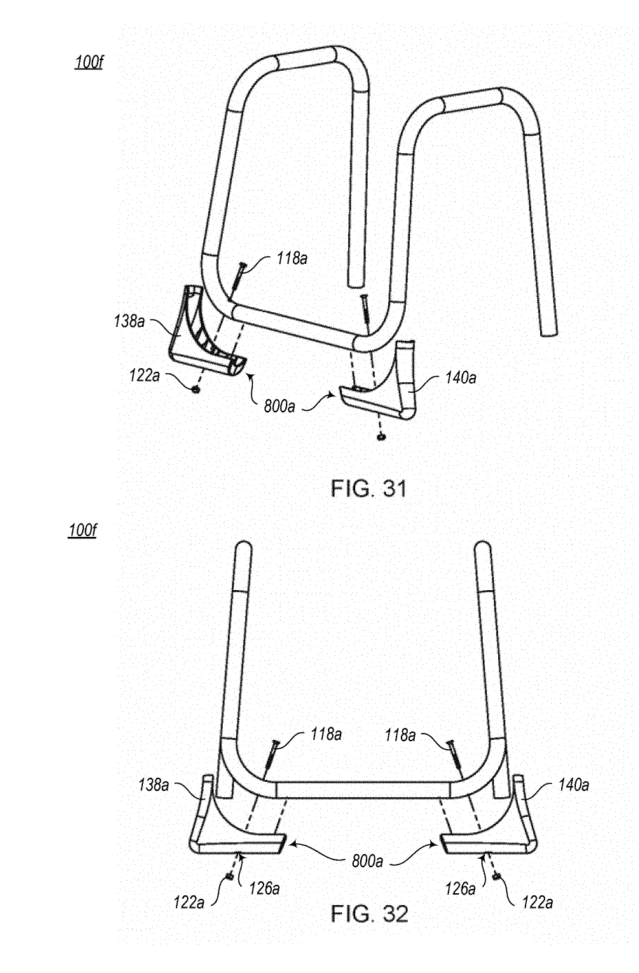

The optional anti-skid/anti-tip component 140a includes a coupling location 126a. The coupling location 126a is formed to allow coupling components 118a, 122a (FIGS. 31, 32) to couple the optional anti-skid/anti-tip component 140a about the support structure 100f. In other and alternative embodiments, the coupling location 126a may be formed to utilize a coupling mechanism such as a press fit connection, a force fit connection, an interference fit connection or some other fastening member, coupling mechanism, or coupling technique to couple the optional anti-skid/anti-tip component 140a to a support structure 100f.

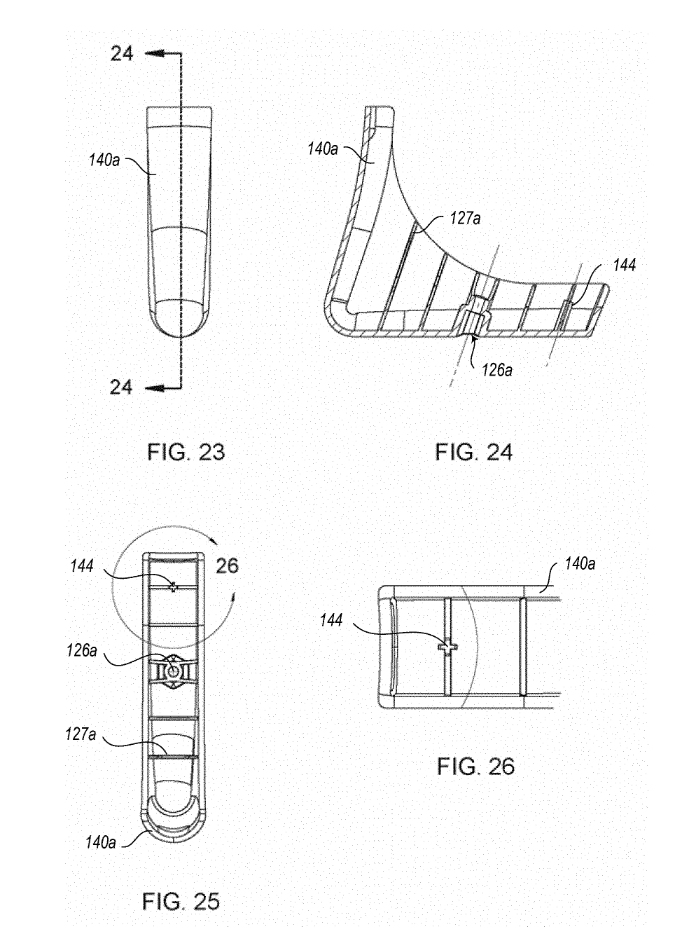

FIG. 23 is a right side view of the optional anti-skid/anti-tip component 140a in FIG. 21.

FIG. 24 is a cross-sectional view taken along 24-24 in FIG. 23 of the optional anti-skid/anti-tip component 140a. The optional anti-skid/anti-tip component 140a includes a plurality of ribs 127a, which are similar to the plurality of ribs 127 in FIG. 14.

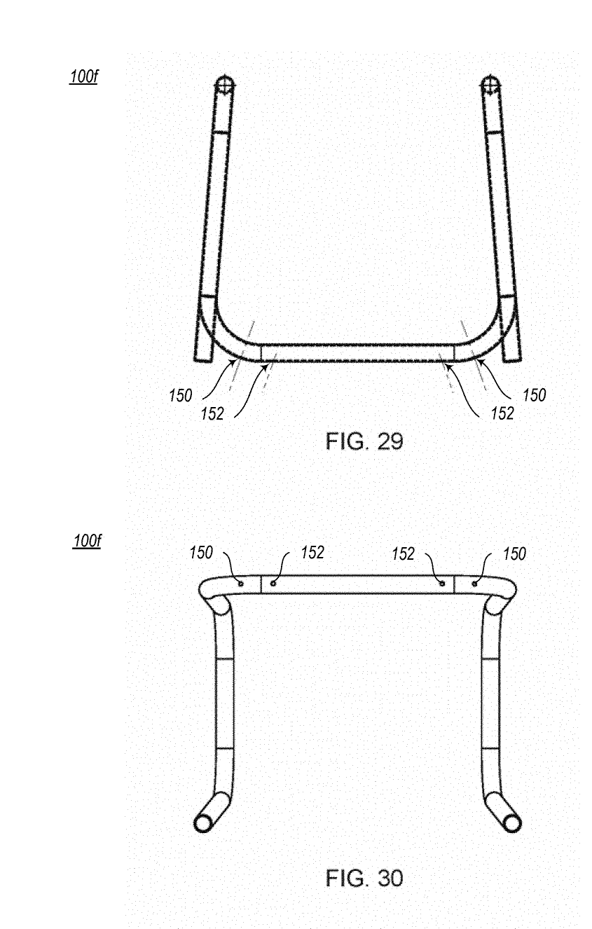

The optional anti-skid/anti-tip component 140a includes a protruding nub 144. In this embodiment, the protruding nub 144 is arranged to slide and fit into a coupling location 152 (FIGS. 29-32) of the support structure 100f. The coupling location 152 is a hole or some other opening or recess that passes partially or fully through the support structure 100f. The coupling location 152 is arranged to receive the protruding nub 144 (FIGS. 30-32). The protruding nub 144 may be formed at a suitable angle to cooperate in a cooperative coupling relationship with the coupling location 152. In other and alternative embodiments, the protruding nub 144 may be arranged normal to a lower face of the anti-skid/anti-tip component 140a.

The protruding nub 144 may have “plus” cross-section, a circular cross-section, an ovular cross-section, a keyed cross-section, or some other cross-section.

In addition, in other and alternative embodiments, the protruding nub 144 may be arranged to have an interference fit, a snap fit, or some other type of fit with the coupling location 152. In some embodiments, the coupling location 152 may be arranged without using a hole, a recess, or any other type of opening.

In some embodiments, the optional anti-skid/anti-tip component 140a may be arranged without a protruding nub 144. Alternatively, in some embodiments, the optional anti-skid/anti-tip component 140a may be arranged with a plurality of protruding nubs and a plurality of coupling locations.

In this embodiment of the optional anti-skid/anti-tip component 140a, the plurality of ribs 127a are arranged to support the support structure 100f when the optional anti-skid/anti-tip component 140a is coupled to the support structure 100f (FIGS. 31-34). The ribs 127a may be formed to provide strength, stability, mating surfaces, mounting surfaces, or for other reasons. The ribs 127a may cooperate with other features (e.g., tubular or other surfaces) in the support structure 100f to reduce an instance of movement of the support structure 100f with the optional anti-skid/anti-tip structure 800a.

In other and alternative embodiments, the ribs 127a may be formed to have one or more thicker dimensions. Such embodiments may be arranged to form a tight or otherwise secure fit around the lower horizontal support member, the third bend, the fourth bend, or some other portion or portions of the support structure 100f. Thicker material may add weight, greater surface area, or one or more other characteristics to the optional anti-skid/anti-tip structure 800a to reduce or avoid movement between the optional anti-skid/anti-tip structure 800a and other portions of the support structure 100f (FIGS. 31-34). Additional size, weight, or still other characteristics may be added to further reduce the likelihood of or even prevent rolling, slipping, tipping, sliding, and other undesirable movement (e.g., motion) of the support structure 100f with the optional anti-skid/anti-tip structure 800a.

In other and alternative embodiments, the plurality of ribs 127a may be combined with another material to add weight to the optional anti-skid/anti-tip structure 800a. For example, the space between the ribs 127a may be filled with any material to add weight to the optional anti-skid/anti-tip structure 800a. The additional weight may further prevent rolling, tipping, slipping, sliding, and other undesirable movement (e.g., motion) of the support structure 100f with the optional anti-skid/anti-tip structure 800a. In another alternative embodiment, the optional anti-skid/anti-tip component 140a may be a solid piece of material.

In this embodiment of the optional anti-skid/anti-tip component 140a, the coupling location 126a is a fastener orifice, which may be a circle, a square, a rectangle, an oval, or of one or more other shapes. The coupling location 126a is arranged to receive a bolt 118a (FIGS. 31-33) at one end and a nut 122a (FIGS. 31-33) at the other end. In other and alternative embodiments, the optional anti-skid/anti-tip component 140a may be arranged to snap onto/into, press onto/into, or be coupled to the support structure 100f at coupling location 126a using some other fastening member, some other coupling components, some other coupling mechanism, or some other coupling technique, any of which coupling means may be desirably selected. The coupling location 126a and the protruding nub 144 of the optional anti-skid/anti-tip component 140a may act as or may be referred to as a cooperative coupling location.

FIG. 25 is a top side view of the optional anti-skid/anti-tip component in FIG. 21. FIG. 26 is a zoomed in top side view of detail 26 in FIG. 25 of the optional anti-skid/anti-tip component 140a.

In this embodiment of the optional anti-skid/anti-tip component 140a in FIGS. 25 and 26, the protruding nub 144 has a plus-sign cross section. In other and alternative embodiments, the protruding nub may have a circular cross section, a square cross section, a rectangular cross section, or a cross section having another selected shape. In other and alternative embodiments, the protruding nub 144 may be arranged to snap into the coupling location 152 or be arranged to be locked in place through an interference fit at the coupling location 152 or be arranged to couple or interact with the support structure 100f utilizing some other coupling components, coupling mechanism or coupling techniques, or some other combination of coupling components, coupling mechanisms, or coupling techniques.

In other and alternative embodiments, the optional anti-skid/anti-tip component 140a may be arranged to have a plurality of protruding nubs 144. In some cases, a plurality of protruding nubs 144 are arranged to form a robust connection between the optional anti-skid/anti-tip structure and the support structure 100f. The plurality of protruding nubs may be arranged to reduce movement between the optional anti-skid/anti-tip component 140a and the support structure 100f, and further reduce the likelihood of or even prevent rolling, slipping, tipping, sliding, and other undesirable movement (e.g., motion) of the support structure 100f with the optional anti-skid/anti-tip structure 800a (FIGS. 31-33).

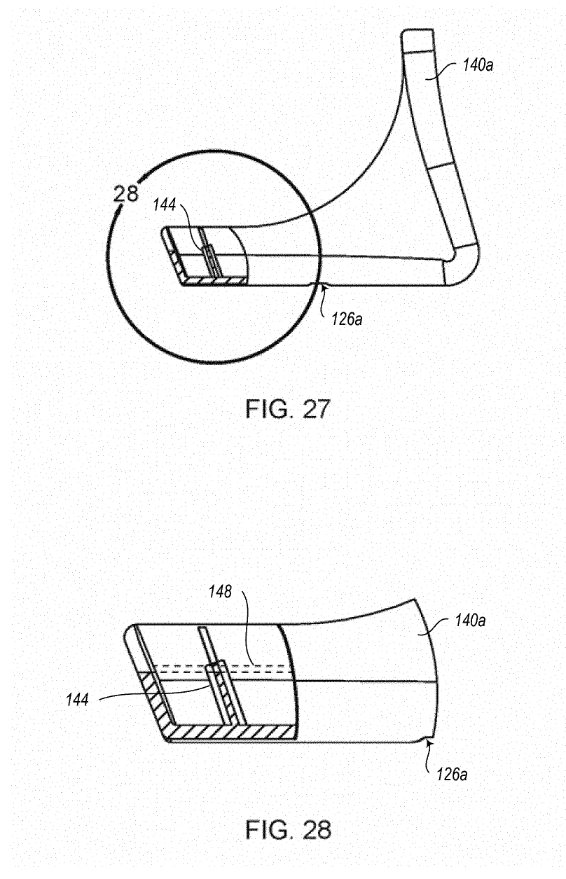

FIG. 27 is a front side view with a cut out detail 28 of the optional anti-skid/anti-tip component 140a in FIG. 21. FIG. 28 is a zoomed in front side view of the cut out detail 28 in FIG. 27 of the protruding nub 144.

In this embodiment of the optional anti-skid/anti-tip component 140a in FIGS. 27 and 28, the dotted lines 148 (FIG. 28) represent where a surface of the support structure 100f would sit when the optional anti-skid/anti-tip component 140a is coupled to the support structure 100f. In this embodiment, the protruding nub 144 extends a short distance (e.g., 0.1 inches, 0.2 inches, 0.3 inches) into the coupling location 152 of the support structure 100f. In other and alternative embodiments, the protruding nub 144 may be arranged to have a greater length, a greater thickness, or a greater width to form a stronger connection between the optional anti-skid/anti-tip component 140a and the support structure 100f. The stronger connection between the optional anti-skid/anti-tip component 140a and the support structure 100f may be formed to reduce the likelihood of or even prevent tipping, slipping, rolling, or any other such undesirable movement (e.g., motion) of the support structure 100f with the optional anti-skid/anti-tip structure 800a (FIGS. 31-33). In other and alternative embodiments, the protruding nub 144 may extend a greater distance (e.g., 0.5 inches, 0.75 inches) into the coupling location 152 of the support structure 100f to form a stronger connection between the support structure 100f and the optional anti-skid/anti-tip structure 140a.

FIG. 29 is a front side view of another embodiment of a support structure 100f, which is similar to support structure 100 in FIG. 1. The support structure 100f includes first coupling locations 150 and second coupling locations 152. FIG. 30 is a bottom side view of the embodiment of the support structure 100f in FIG. 29.

In this embodiment of the support structure 100f of FIGS. 28 and 29, the first coupling locations 150 are openings, holes, scored locations, thinned locations, or other pass-through means that identify where a coupling component 118 is arranged to pass in or through the support structure 100f. The second coupling locations 152 are pass-through means along the lines of first coupling locations 150. In other and alternative embodiments, the pass-through means at the first coupling locations 150 and the second coupling locations 152 may be arranged to all pass through the support structure 100f, to all partially pass through the support structure 100f, or any other combination of distances extending into or through the support structure 100f.

In some embodiments, the first coupling locations 150 are arranged to receive a bolt 118a and a nut 122a. The second coupling locations 152 are arranged to receive the protruding nub 144 of the optional anti-skid/anti-tip components 138a, 140a. In other and alternative embodiments, the coupling locations 150, 152 may be arranged to both receive a bolt and a nut, both receive a protruding nub, both receive a snap fit, both receive an interference fit, both receive a force fit, or both receive any other coupling means component or be coupled to the support structure 100f by utilizing any other coupling technique or coupling mechanism.

In FIGS. 31-33, two opposing anti-skid/anti-tip components 138a, 140a are coupled to the support structure 100f. The two opposing anti-skid/anti-tip components 138a, 140a may be referred to as a first optional anti-skid/anti-tip component and a second optional anti-skid/anti-tip component 138a, 140a, respectively or vice versa. In some embodiments, first and second optional anti-skid/anti-tip components 138a, 140a are arranged to be exactly alike and interchangeable. In other embodiments, first and second optional anti-skid/anti-tip components 138a, 140a are arranged as having inverse (e.g., mirror image, complimentary, or the like) characteristics. One of ordinary skill in the art will recognize that the discussion herein with respect to the optional anti-skid/anti-tip component 140a may be suitably applied to the optional anti-skid/anti-tip component 138a, and vice versa.

FIG. 31 is an exploded perspective view of another embodiment of a support structure 100f with optional features, which is similar to the support structure 100 with optional features of FIG. 1. FIG. 32 is an exploded front side view of the support structure 100f with optional features in FIG. 31.

In this embodiment of the support structure 100f with optional features in FIGS. 31 and 32, the support structure 100f is coupled to the optional anti-skid/anti-tip structure 800a. The optional anti-skid/anti-tip structure 800a includes the optional anti-skid/anti-tip component 138a and the optional anti-skid/anti-tip component 140a. The optional anti-skid/anti-tip components 138a, 140a are coupled to the support structure 100f utilizing bolts 118a, nuts 122a and protruding portions 144 of the optional anti-skid/anti-tip components 138a, 140a.

In this embodiment of the support structure 100f with the optional anti-skid/anti-tip structure 800a, the coupling location 126a and the protruding nub 144 of the optional anti-skid/anti-tip components 138a, 140a are aligned with the respective coupling locations 150, 152 of the support structure 100f. Bolts 118a pass through the respective coupling locations 126a of the optional anti-skid/anti-tip component 138a, 140a and the coupling locations 152 of the support structure 100f. The protruding portions 144 of the optional anti-skid/anti-tip components 138a, 140a enter the coupling locations 150 of the support structure 100f. Nuts 122a are coupled to bolts 118a thereby coupling the optional anti-skid/anti-tip components 138a, 140a to the support structure 100f. The optional anti-skid/anti-components 138a, 140a reduce the likelihood of or even prevent tipping, slipping, rolling, or any other such undesirable movement (e.g., motion) of the support structure 100f with the optional anti-skid/anti-tip structure 800a. The coupling location 126a and the protruding portion 144 of the optional anti-skid/anti-tip components 138a, 140a may be referred to as a cooperative coupling location.

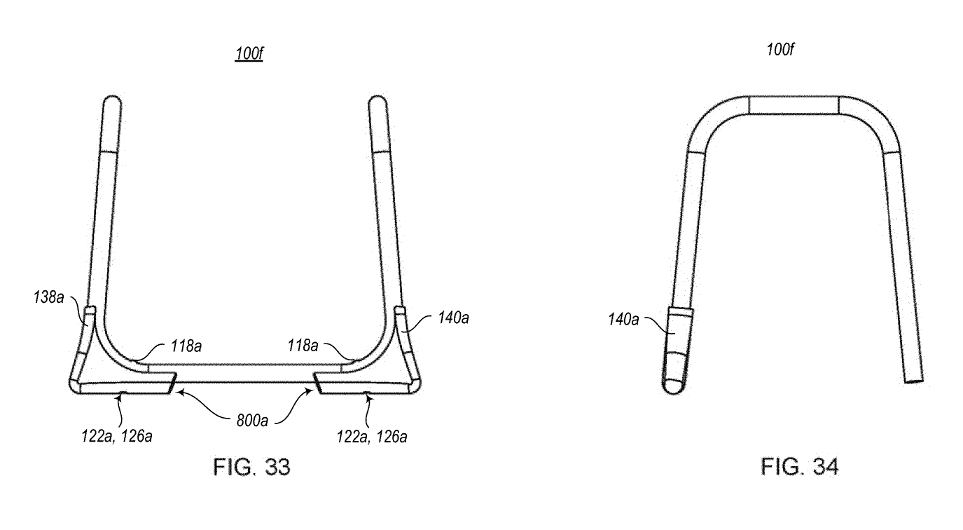

FIG. 33 is a front side view of the embodiment of the support structure 100f with the optional anti-skid/anti-tip components 138a, 140a. FIG. 34 is a right side view of the embodiment of the support structure 100f with the optional anti-skid/anti-tip components 138a, 140a as in FIG. 33, and illustrating only a single anti-skid/anti-tip component 140a.

In this embodiment of the support structure 100f with the optional anti-skid/anti-tip components 138a, 140a, which together form the optional anti-skid/anti-tip structure 800a of FIGS. 33 and 34, nuts 122a are recessed in an orifice at the bottom surfaces, respectively, of the optional anti-skid/anti-tip components 138a, 140a. The orifices may be formed as a portion of the coupling locations 126a of the optional anti-skid/anti-tip components 138a, 140a. In other and alternative embodiments, nuts 122a may be flush with the bottom surface of the optional anti-skid/anti-tip components 138a, 140a, or may protrude from the bottom surfaces of the second anti-skid/anti-tip components 138a, 140a.

In the alternative embodiment with protruding nuts, the protruding nuts may provide greater traction on various surfaces. In addition, the embodiment with protruding nuts may provide a mounting surface for other traction materials such as rubber, plastic, or any other suitable material arranged to provide suitable (e.g., increased, decreased, variable, or the like) traction on various surfaces to avoid slipping, rolling, tipping, or any other undesirable movement (e.g., motion) of the support structure 100f with the optional anti-skid/anti-tip structure 800a.

In other and alternative embodiments, the support structure 100f may include the optional plugs 112 (FIG. 14). The optional plugs 112 are placed at the ends of the support structure 100f. The optional plugs 112 may be arranged to reduce the likelihood of or even prevent rolling, slipping, tipping, falling, or any other undesirable movement (e.g., motion) of the support structure 100f. The optional plugs 112 may be included in any of the embodiments or other and alternative embodiments.

In the foregoing description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with electronic and computing systems including client and server computing systems, as well as networks have not been shown or described in detail to avoid unnecessarily obscuring descriptions of the embodiments.

The terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Unless the context requires otherwise, throughout the specification and claims which follow, the word “comprise” and variations thereof, such as, “comprises” and “comprising” are to be construed in an open, inclusive sense, e.g., “including, but not limited to.”

Reference throughout this specification to “one embodiment” or “an embodiment” and variations thereof means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

As described herein, for simplicity, patients, persons, human beings, and the like are in some case described in the context of the male gender. For example, the terms “his hand,” “his left thumb,” and the like are used. It is understood that human beings of any condition or status can be of any gender, and the terms “he,” “his,” and the like as used herein are to be interpreted broadly inclusive of all known gender definitions.

As described herein, terms such as stiff, soft, flexible, pliable, and the like are understood in their common and ordinary meaning. For example, stiff is not necessarily completely un-bendable. Instead, something that is stiff resistance deformation to a desired degree. The desired degree of stiffness may be measured, for example, in units such as foot pounds per inch or some other units. One structure may be stiffer than another structure. The increased (or decreased) stiffness may be caused by the devices being formed from different materials, from materials having different physical or chemical properties, or for some other reason. Correspondingly, the terms “flexible,” “flexibility,” “pliable,” “soft,” and the like impart a desired degree of flexibility or softness to the structure which the term modifies.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

In the absence of any specific clarification related to its express use in a particular context, where the terms “substantial” or “about” in any grammatical form are used as modifiers in the present disclosure and any appended claims (e.g., to modify a structure, a dimension, a measurement, or some other characteristic), it is understood that the characteristic may vary by up to 30 percent. For example, a support structure 100 may be described as having “substantially straight sections,” In these cases, a section that is exactly straight has a length that forms a straight line from a proximal end to a distal end, and any three or more points along the line will have zero degrees of variance. As another example to add clarity, two exactly straight sections of a support structure, if arranged normal to each other, will maintain a right angle (i.e., 90 degrees) at all corresponding points along their entire lengths as if to form a virtual plane where one section forms an “X” axis and the other section forms a “Y” axis. Different from the exact precision of the term, “straight,” the use of “substantially” to modify the characteristic permits a variance of the “straight” characteristic by up to 30 percent. Accordingly, a support structure 100 that has “substantially straight sections” includes structure having sections that may vary between [63] degrees and [117] degrees at one or more portions along their length. For the avoidance of doubt, a section of a support structure having a 45 degree bend is not a “substantially straight section.” As another example, a support structure 100 may be described as having substantially hollow sections. A support structure having a section a volume that is formed 30 percent solid or less is a “substantially hollow” section, and a section having a volume that is more than 30 percent solid is not substantially hollow. As yet one more example, a section length that is “between about [6] inches and [10] inches” includes such sections in which the linear dimension varies by up to 30 percent. Accordingly, the particular linear dimension of the section may be between 3 inches and 13 inches.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A support frame to assist a human being to move upwards, the support frame comprising:
a single conduit structure having distinct horizontal support portions including:
a first horizontal support member corresponding to a first edge of the single conduit structure;
a second horizontal support member corresponding to a second edge of the single conduit support structure, the second horizontal support member being substantially parallel with the first horizontal support member; and
a lower horizontal support member corresponding to a third edge of the single conduit structure, the lower horizontal member being substantially transverse to the first and the second horizontal support members, the lower horizontal support member having at least two coupling locations;
one or more anti-skid/anti-tip structures positioned at the lower horizontal support member, each anti-skid/anti-tip structure having a cooperative coupling location aligned with at least one of the coupling locations of the lower horizontal support member.

2. The support frame of claim 1, wherein the support frame is configured to assist the human being overcome at least one effect of a debilitated joint, the debilitated joint being an artificial hip joint or an artificial knee joint.

3. The support frame of claim 1, wherein the one or more anti-skid/anti-tip structures further includes another cooperative coupling location aligned with another one of the at least two coupling locations of the lower horizontal support member.

4. The support frame of claim 1, wherein the anti-skid/anti-tip structures positioned at the lower horizontal support member further includes at least one positive locking structure coupling the one or more anti-skid/anti-tip structures to the lower horizontal support member.

5. The support frame of claim 1, wherein each of the first horizontal support member and the second horizontal support member includes a handle.

6. The support frame of claim 1, wherein at least one of the at least two coupling locations includes a recess and the cooperative coupling location includes a protruding nub arranged to mate with the recess.

7. The support frame of claim 4, wherein the at least one positive locking structure includes at least one threaded structure.

8. The support frame of claim 1, wherein the support frame includes at least two separate and distinct anti-skid/anti-tip structures.

9. The support frame of claim 1, wherein the one or more anti-skid/anti-tip structures have a radius that corresponds to at least one bend of the single conduit structure.

10. The support frame of claim 1, the single conduit structure further includes distinct vertical support portions including:
a first vertical support member coupling the first horizontal support member to the lower horizontal support member;
a second vertical support member coupling the second horizontal support member to the lower horizontal support member;
a third vertical support member coupled to the first horizontal support member; and
a fourth vertical support member coupled to the second horizontal support member.

11. The support frame of claim 1, wherein the one or more anti-skid/anti-tip support structures further include a plurality of half ellipses along a base of the one or more anti-skid/anti-tip support structures.

12. A support frame to assist a human being to move upwards, the support frame comprising:
a single conduit bent in at least six locations to form the support frame, four locations of the at least six locations contributing to form separate ones of four substantially vertical support structure portions, a fifth location of the at least six locations contributing to form a lower horizontal support structure portion, and a sixth location of the at least six locations contributing to form the lower horizontal support structure portion;
a first anti-skid/anti-tip structure portion positioned at a coupling region of the fifth location; and
a second anti-skid/anti-tip structure portion positioned at a coupling region of the sixth location.

13. The support frame of claim 12, further comprising:
a first upper horizontal support structure portion extending from a first respective substantially vertical support portion to a second respective substantially vertical support portion; and
a second upper horizontal support structure portion extending from a third respective substantially vertical support portion and a fourth respective substantially vertical support portion.

14. The support frame of claim 12, further comprising a first handle and a second handle coupled to the single conduit.

15. The support frame of claim 12, further comprising:
a first fastening member coupling the first anti-skid/anti-tip structure portion to the single conduit; and
a second fastening member coupling the second anti-skid/anti-tip structure portion to the single conduit.

16. A support frame for assisting a human being to move upwards, the support frame comprising:
a single conduit bent to form at least seven distinct linear portions of the support frame, four of the at least seven distinct linear portions forming substantially vertical supports and three of the at least seven distinct linear portions forming substantially horizontal supports, wherein two of the three substantially horizontal supports are upper horizontal supports and a remaining one of the three substantially horizontal supports is a lower horizontal support;
a first anti-skid/anti-tip structure portion positioned at a first coupling region of the lower horizontal support; and
a second anti-skid/anti-tip structure portion positioned at a second coupling region of the lower horizontal support.

17. The support frame of claim 16, wherein the lower horizontal support further includes a first fastener orifice at the first coupling region and a second fastener orifice at the second coupling region.

18. The support frame of claim 17, wherein the first anti-skid/anti-tip structure portion is coupled to the first coupling region of the lower horizontal support by a bolt and a nut, the bolt extending through the first anti-skid/anti-tip structure portion and the first fastener orifice.

19. The support frame of claim 17, wherein the second anti-skid/anti-tip structure portion is coupled to the second coupling region of the lower horizontal support by a bolt and nut, the bolt extending through the second anti-skid/anti-tip structure portion and the second fastener orifice.

20. The support frame of claim 16, further includes a first plug placed at a first end of the single conduit, and a second plug placed at a second end of the single conduit.
